(19) United States
(12) Patent Application Publication
(10) Pub. No.: US 2024/0137097 A1
(43) Pub. Date: Apr. 25, 2024

(54) REPORTING BEAM SEQUENCE FOR WIRELESS COMMUNICATION

(71) Applicant: Lenovo (Singapore) Pte. Ltd., New Tech Park (SG)

(72) Inventors: Ankit Bhamri, Rödermark (DE); Hyejung Jung, Northbrook, IL (US)

(21) Appl. No.: 18/547,285

(22) PCT Filed: Feb. 18, 2022
(86) PCT No.: PCT/IB2022/051477

§ 371 Date: Aug. 20, 2023

Related U.S. Application Data
(60) Provisional application No. 63/151,604, filed on Feb. 19, 2021.

(51) Int. Cl. H04B 7/06

(52) U.S. Cl. CPC H04B 7/06952; H04B 7/0626

(57) ABSTRACT

Apparatuses, methods, and systems are disclosed for Channel State Information (“CSC”) reporting. One apparatus includes a transceiver that receives a configuration from a radio access network (“RAN”) to report a sequence of beams that are applicable for wireless communication, and a processor that that performs beam quality measurements on resources configured by the RAN. The processor determines a sequence of beams based on the measurements and the transceiver reports the sequence of beams to the RAN, where the sequence of beams contains a series of best beams for a period of time.

### CROSS-REFERENCE TO RELATED APPLICATIONS

This application claims priority to U.S. Provisional Patent Application No. 63/151,604 entitled “CSI REPORTING PREDICTION” and filed on Feb. 19, 2021 for Ankit Bhamri and Hyejung Jung, which application is incorporated herein by reference.

### FIELD

The subject matter disclosed herein relates generally to wireless communications and more particularly relates to Channel State Information (“CSI”) reporting to facilitate prediction in terms of beam reporting and corresponding channel/interference measurements.

### BACKGROUND

In certain wireless communication systems, beam-based communication may be supported. Beam-management procedures — including initial beam acquisition, beam training, beam refinement and beam failure recovery — rely heavily on constant and/or periodic exchange of reference signals and corresponding measurement reporting between the network and User Equipment (“UE”) for both uplink (“UL”) and downlink (“DL”) control and/or data channel transmissions.

### BRIEF SUMMARY

Disclosed are procedures for CSI reporting prediction. Said procedures may be implemented by apparatus, systems, methods, or computer program products.

One method at a UE for CSI reporting prediction includes receiving a configuration from a radio access network (“RAN”) to report a sequence of beams that are applicable for wireless communication and performing beam quality measurements on resources configured by the RAN. The method includes determining a sequence of beams based on the measurements and reporting the sequence of beams to the RAN, where the sequence of beams contains a series of best beams for a period of time.

One method at a RAN for CSI reporting prediction includes transmitting a configuration to a UE for reporting a sequence of beams that are applicable for wireless communication. The method includes transmitting one or more reference signals using one or more resources configured by RAN and receiving a sequence of beams from the UE, where the sequence of beams contains a series of best beams for a period of time.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a block diagram illustrating one embodiment of a wireless communication system for CSI reporting prediction;

FIG. 2 is a diagram illustrating one embodiment of a Third Generation Partnership Project (“3GPP”) New Radio (“NR”) protocol stack;

FIG. 3 is a call-flow diagram illustrating one embodiment of procedure for beams sequence and duration reporting;

FIG. 4 is a call-flow diagram illustrating one embodiment of procedure for CSI reporting for reported sequence of beams;

FIG. 5 is a call-flow diagram illustrating one embodiment of procedure for Transmission Reception Point (“TRP”) sequence, duration, and CSI reporting;

FIG. 6 is a block diagram illustrating one embodiment of a user equipment apparatus that may be used for CSI reporting prediction;

FIG. 7 is a block diagram illustrating one embodiment of a network apparatus that may be used for CSI reporting prediction;

FIG. 8 is a flowchart diagram illustrating one embodiment of a first method for CSI reporting prediction; and

FIG. 9 is a flowchart diagram illustrating one embodiment of a second method for CSI reporting prediction.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects.

For example, the disclosed embodiments may be implemented as a hardware circuit comprising custom very-large-scale integration (“VLSI”) circuits or gate arrays, off-the-shelf semiconductors such as logic chips, transistors, or other discrete components. The disclosed embodiments may also be implemented in programmable hardware devices such as field programmable gate arrays, programmable array logic, programmable logic devices, or the like. As another example, the disclosed embodiments may include one or more physical or logical blocks of executable code which may, for instance, be organized as an object, procedure, or function.

Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random-access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain or store a program for use by or in connection with an instruction execution system, apparatus, or device.

Code for carrying out operations for embodiments may be any number of lines and may be written in any combination of one or more programming languages including an object-oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”), wireless LAN (“WLAN”), or a wide area network (“WAN”), or the connection may be made to an external computer (for example, through the Internet using an Internet Service Provider (“ISP”)).

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

As used herein, a list with a conjunction of “and/or” includes any single item in the list or a combination of items in the list. For example, a list of A, B and/or C includes only A, only B, only C, a combination of A and B, a combination of B and C, a combination of A and C or a combination of A, B and C. As used herein, a list using the terminology “one or more of” includes any single item in the list or a combination of items in the list. For example, one or more of A, B and C includes only A, only B, only C, a combination of A and B, a combination of B and C, a combination of A and C or a combination of A, B and C. As used herein, a list using the terminology “one of” includes one and only one of any single item in the list. For example, “one of A, B and C” includes only A, only B or only C and excludes combinations of A, B and C. As used herein, “a member selected from the group consisting of A, B, and C,” includes one and only one of A, B, or C, and excludes combinations of A, B, and C.” As used herein, “a member selected from the group consisting of A, B, and C and combinations thereof” includes only A, only B, only C, a combination of A and B, a combination of B and C, a combination of A and C or a combination of A, B and C.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. This code may be provided to a processor of a general-purpose computer, special purpose computer, or other programmable data processing apparatus to produce a machine, such that the instructions, which execute via the processor of the computer or other programmable data processing apparatus, create means for implementing the functions/acts specified in the flowchart diagrams and/or block diagrams.

The code may also be stored in a storage device that can direct a computer, other programmable data processing apparatus, or other devices to function in a particular manner, such that the instructions stored in the storage device produce an article of manufacture including instructions which implement the function/act specified in the flowchart diagrams and/or block diagrams.

The code may also be loaded onto a computer, other programmable data processing apparatus, or other devices to cause a series of operational steps to be performed on the computer, other programmable apparatus, or other devices to produce a computer implemented process such that the code which execute on the computer or other programmable apparatus provide processes for implementing the functions/acts specified in the flowchart diagrams and/or block diagrams.

The call-flow diagrams, flowchart diagrams and/or block diagrams in the Figures illustrate the architecture, functionality, and operation of possible implementations of apparatuses, systems, methods, and program products according to various embodiments. In this regard, each block in the flowchart diagrams and/or block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the call-flow, flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

Generally, the present disclosure describes systems, methods, and apparatus for CSI reporting prediction. In certain embodiments, the methods may be performed using computer code embedded on a computer-readable medium. In certain embodiments, an apparatus or system may include a computer-readable medium containing computer-readable code which, when executed by a processor, causes the apparatus or system to perform at least a portion of the below described solutions.

Disclosed are solutions for CSI reporting enhancements. The solutions may be implemented by apparatus, systems, methods, and/or computer program products. In various embodiments, the UE is configured to report a sequence of beams and corresponding quantities including Layer-1 Reference Signal Received Power (“L1-RSRP”) and/or Layer-1 Signal-to-Interference-Plus-Noise Ratio (“L1-SINR”) and/or Channel Quality Indicator (“CQI”) and/or Rank Indicator (“RI”) and/or Layer Indicator (“LI”) and/or Precoding Matrix Indicator (“PMI”). New CSI reporting is described to allow for reporting a sequence of beams and/or TRPs based on configured measurements on multiple beams, where the number of beams within the sequence can be configured in the reporting settings. Additionally, the UE may also report an applicability duration for each of the reported beams (and/or corresponding reporting quantities). In further solutions, the UE may report CSI for each of the beams and/or Transmission Reception Points (“TRPs”) within the sequence reported by the UE.

Some of the benefits of the proposed solutions are that prediction in terms of CSI reporting for updating the beams could greatly reduce the need for more frequent beam-related measurements and corresponding reporting quantities. Furthermore, it allows the RAN (i.e., gNB) to configure further CSI Reference Signal (“CSI-RS”) resources for channel and/or interference measurements in an efficient manner based on the sequence of beams that reported by UE.

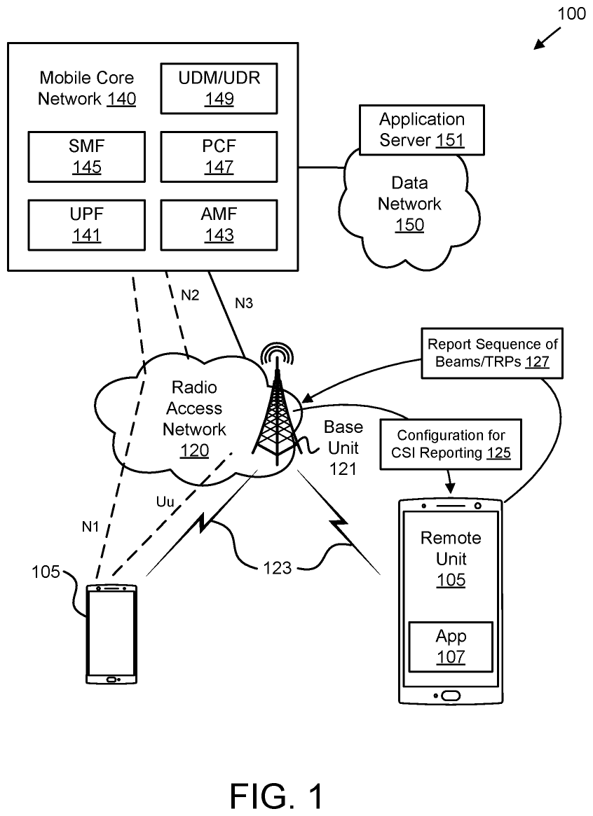

FIG. 1 depicts a wireless communication system 100 for CSI reporting prediction, according to embodiments of the disclosure. In one embodiment, the wireless communication system 100 includes at least one remote unit 105, a radio access network (“RAN”) 120, and a mobile core network 140. The RAN 120 and the mobile core network 140 form a mobile communication network. The RAN 120 may be composed of a base unit 121 with which the remote unit 105 communicates using wireless communication links 123. Even though a specific number of remote units 105, base units 121, wireless communication links 123, RANs 120, and mobile core networks 140 are depicted in FIG. 1, one of skill in the art will recognize that any number of remote units 105, base units 121, wireless communication links 123, RANs 120, and mobile core networks 140 may be included in the wireless communication system 100.

In one implementation, the RAN 120 is compliant with the Fifth-Generation (“5G”) cellular system specified in the Third Generation Partnership Project (“3GPP”) specifications. For example, the RAN 120 may be a Next Generation Radio Access Network (“NG-RAN”), implementing New Radio (“NR”) Radio Access Technology (“RAT”) and/or Long-Term Evolution (“LTE”) RAT. In another example, the RAN 120 may include non-3GPP RAT (e.g., Wi-Fi® or Institute of Electrical and Electronics Engineers (“IEEE”) 802.11-family compliant WLAN). In another implementation, the RAN 120 is compliant with the LTE system specified in the 3GPP specifications. More generally, however, the wireless communication system 100 may implement some other open or proprietary communication network, for example Worldwide Interoperability for Microwave Access (“WiMAX”) or IEEE 802.16-family standards, among other networks. The present disclosure is not intended to be limited to the implementation of any particular wireless communication system architecture or protocol.

In one embodiment, the remote units 105 may include computing devices, such as desktop computers, laptop computers, personal digital assistants (“PDAs”), tablet computers, smart phones, smart televisions (e.g., televisions connected to the Internet), smart appliances (e.g., appliances connected to the Internet), set-top boxes, game consoles, security systems (including security cameras), vehicle on-board computers, network devices (e.g., routers, switches, modems), or the like. In some embodiments, the remote units 105 include wearable devices, such as smart watches, fitness bands, optical head-mounted displays, or the like. Moreover, the remote units 105 may be referred to as the UEs, subscriber units, mobiles, mobile stations, users, terminals, mobile terminals, fixed terminals, subscriber stations, user terminals, wireless transmit/receive unit (“WTRU”), a device, or by other terminology used in the art. In various embodiments, the remote unit 105 includes a subscriber identity and/or identification module (“SIM”) and the mobile equipment (“ME”) providing mobile termination functions (e.g., radio transmission, handover, speech encoding and decoding, error detection and correction, signaling and access to the SIM). In certain embodiments, the remote unit 105 may include a terminal equipment (“TE”) and/or be embedded in an appliance or device (e.g., a computing device, as described above).

The remote units 105 may communicate directly with one or more of the base units 121 in the RAN 120 via uplink (“UL”) and downlink (“DL”) communication signals.

Furthermore, the UL and DL communication signals may be carried over the wireless communication links 123. Furthermore, the UL communication signals may comprise one or more uplink channels, such as the Physical Uplink Control Channel (“PUCCH”) and/or Physical Uplink Shared Channel (“PUSCH”), while the DL communication signals may comprise one or more downlink channels, such as the Physical Downlink Control Channel (“PDCCH”) and/or Physical Downlink Shared Channel (“PDSCH”). Here, the RAN 120 is an intermediate network that provides the remote units 105 with access to the mobile core network 140.

In some embodiments, the remote units 105 communicate with an application server 151 via a network connection with the mobile core network 140. For example, an application 107 (e.g., web browser, media client, telephone and/or Voice-over-Internet-Protocol (“VoIP”) application) in a remote unit 105 may trigger the remote unit 105 to establish a protocol data unit (“PDU”) session (or other data connection) with the mobile core network 140 via the RAN 120. The mobile core network 140 then relays traffic between the remote unit 105 and the application server 151 in the packet data network 150 using the PDU session. The PDU session represents a logical connection between the remote unit 105 and the User Plane Function (“UPF”) 141.

In order to establish the PDU session (or PDN connection), the remote unit 105 must be registered with the mobile core network 140 (also referred to as “attached to the mobile core network” in the context of a Fourth Generation (“4G”) system). Note that the remote unit 105 may establish one or more PDU sessions (or other data connections) with the mobile core network 140. As such, the remote unit 105 may have at least one PDU session for communicating with the packet data network 150. The remote unit 105 may establish additional PDU sessions for communicating with other data networks and/or other communication peers.

In the context of a 5G system (“5GS”), the term “PDU Session” refers to a data connection that provides end-to-end (“E2E”) user plane (“UP”) connectivity between the remote unit 105 and a specific Data Network (“DN”) through the UPF 141. A PDU Session supports one or more Quality of Service (“QoS”) Flows. In certain embodiments, there may be a one-to-one mapping between a QoS Flow and a QoS profile, such that all packets belonging to a specific QoS Flow have the same 5G QoS Identifier (“5QI”).

In the context of a 4G/LTE system, such as the Evolved Packet System (“EPS”), a Packet Data Network (“PDN”) connection (also referred to as EPS session) provides E2E UP connectivity between the remote unit and a PDN. The PDN connectivity procedure establishes an EPS Bearer, i.e., a tunnel between the remote unit 105 and a PDN Gateway (“PGW,” not shown) in the mobile core network 140. In certain embodiments, there is a one-to-one mapping between an EPS Bearer and a QoS profile, such that all packets belonging to a specific EPS Bearer have the same QoS Class Identifier (“QCI”).

The base units 121 may be distributed over a geographic region. In certain embodiments, a base unit 121 may also be referred to as an access terminal, an access point, a base, a base station, a Node-B (“NB”), an Evolved Node B (abbreviated as eNodeB or “eNB,” also known as Evolved Universal Terrestrial Radio Access Network (“E-UTRAN”) Node B), a 5G/NR Node B (“gNB”), a Home Node-B, a relay node, a RAN node, or by any other terminology used in the art. The base units 121 are generally part of a RAN, such as the RAN 120, that may include one or more controllers communicably coupled to one or more corresponding base units 121. These and other elements of radio access network are not illustrated but are well known generally by those having ordinary skill in the art. The base units 121 connect to the mobile core network 140 via the RAN 120.

The base units 121 may serve a number of remote units 105 within a serving area, for example, a cell or a cell sector, via a wireless communication link 123. The base units 121 may communicate directly with one or more of the remote units 105 via communication signals. Generally, the base units 121 transmit DL communication signals to serve the remote units 105 in the time, frequency, and/or spatial domain. Furthermore, the DL communication signals may be carried over the wireless communication links 123. The wireless communication links 123 may be any suitable carrier in licensed or unlicensed radio spectrum. The wireless communication links 123 facilitate communication between one or more of the remote units 105 and/or one or more of the base units 121.

Note that during NR operation on unlicensed spectrum (referred to as “NR-U”), the base unit 121 and the remote unit 105 communicate over unlicensed (i.e., shared) radio spectrum. Similarly, during LTE operation on unlicensed spectrum (referred to as “LTE-U”), the base unit 121 and the remote unit 105 also communicate over unlicensed (i.e., shared) radio spectrum.

In one embodiment, the mobile core network 140 is a 5G Core network (“5GC”) or an Evolved Packet Core (“EPC”), which may be coupled to a packet data network 150, like the Internet and private data networks, among other data networks. A remote unit 105 may have a subscription or other account with the mobile core network 140. In various embodiments, each mobile core network 140 belongs to a single mobile network operator (“MNO”) and/or Public Land Mobile Network (“PLMN”). The present disclosure is not intended to be limited to the implementation of any particular wireless communication system architecture or protocol.

The mobile core network 140 includes several network functions (“NFs”). As depicted, the mobile core network 140 includes at least one UPF 141. The mobile core network 140 also includes multiple control plane (“CP”) functions including, but not limited to, an Access and Mobility Management Function (“AMF”) 143 that serves the RAN 120, a Session Management Function (“SMF”) 145, a Policy Control Function (“PCF”) 147, a Unified Data Management function (“UDM”) and a User Data Repository (“UDR”). In some embodiments, the UDM is co-located with the UDR, depicted as combined entity “UDM/UDR” 149. Although specific numbers and types of network functions are depicted in FIG. 1, one of skill in the art will recognize that any number and type of network functions may be included in the mobile core network 140.

The UPF(s) 141 is/are responsible for packet routing and forwarding, packet inspection, QoS handling, and external PDU session for interconnecting Data Network (“DN”), in the 5G architecture. The AMF 143 is responsible for termination of Non-Access Spectrum (“NAS”) signaling, NAS ciphering & integrity protection, registration management, connection management, mobility management, access authentication and authorization, security context management. The SMF 145 is responsible for session management (i.e., session establishment, modification, release), remote unit (i.e., UE) Internet Protocol (“IP”) address allocation & management, DL data notification, and traffic steering configuration of the UPF 141 for proper traffic routing.

The PCF 147 is responsible for unified policy framework, providing policy rules to CP functions, access subscription information for policy decisions in UDR. The UDM is responsible for generation of Authentication and Key Agreement (“AKA”) credentials, user identification handling, access authorization, subscription management. The UDR is a repository of subscriber information and may be used to service a number of network functions. For example, the UDR may store subscription data, policy-related data, subscriber-related data that is permitted to be exposed to third party applications, and the like.

In various embodiments, the mobile core network 140 may also include a Network Repository Function (“NRF”) (which provides Network Function (“NF”) service registration and discovery, enabling NFs to identify appropriate services in one another and communicate with each other over Application Programming Interfaces (“APIs”)), a Network Exposure Function (“NEF”) (which is responsible for making network data and resources easily accessible to customers and network partners), an Authentication Server Function (“AUSF”), or other NFs defined for the 5GC. When present, the AUSF may act as an authentication server and/or authentication proxy, thereby allowing the AMF 143 to authenticate a remote unit 105. In certain embodiments, the mobile core network 140 may include an authentication, authorization, and accounting (“AAA”) server.

In various embodiments, the mobile core network 140 supports different types of mobile data connections and different types of network slices, wherein each mobile data connection utilizes a specific network slice. Here, a “network slice” refers to a portion of the mobile core network 140 optimized for a certain traffic type or communication service. For example, one or more network slices may be optimized for enhanced mobile broadband (“eMBB”) service. As another example, one or more network slices may be optimized for ultra-reliable low-latency communication (“URLLC”) service. In other examples, a network slice may be optimized for machine type communication (“MTC”) service, massive MTC (“mMTC”) service, Internet-of-Things (“IoT”) service. In yet other examples, a network slice may be deployed for a specific application service, a vertical service, a specific use case, etc.

A network slice instance may be identified by a single-network slice selection assistance information (“S-NSSAI”) while a set of network slices for which the remote unit 105 is authorized to use is identified by network slice selection assistance information (“NSSAI”). Here, “NSSAI” refers to a vector value including one or more S-NSSAI values. In certain embodiments, the various network slices may include separate instances of network functions, such as the SMF 145 and UPF 141. In some embodiments, the different network slices may share some common network functions, such as the AMF 143. The different network slices are not shown in FIG. 1 for ease of illustration, but their support is assumed.

While FIG. 1 depicts components of a 5G RAN and a 5G core network, the described embodiments for CSI reporting prediction apply to other types of communication networks and RATs, including IEEE 802.11 variants, Global System for Mobile Communications (“GSM,” i.e., a 2G digital cellular network), General Packet Radio Service (“GPRS”), Universal Mobile Telecommunications System (“UMTS”), LTE variants, CDMA 2000, Bluetooth, ZigBee, Sigfox, and the like.

Moreover, in an LTE variant where the mobile core network 140 is an EPC, the depicted network functions may be replaced with appropriate EPC entities, such as a Mobility Management Entity (“MME”), a Serving Gateway (“SGW”), a PGW, a Home Subscriber Server (“HSS”), and the like. For example, the AMF 143 may be mapped to an MME, the SMF 145 may be mapped to a control plane portion of a PGW and/or to an MME, the UPF 141 may be mapped to an SGW and a user plane portion of the PGW, the UDM/UDR 149 may be mapped to an HSS, etc.

Communication devices, such as the remote unit 105 may be required to report the best radio resources (e.g., beams, TRPs) for communication by measuring one or more Channel State Information Reference Signals (“CSI-RS”) transmitted by a base unit 121, determining a sequence of best beams (alternatively, a sequency of best TRPs) and transmitting a report 127 with the sequence of best beams (or best TRPs) to the base unit 121. In various embodiments, the base unit 121 sends a CSI reporting configuration 125 to the remote unit 105 for performing measurements and reporting a sequence of best beams, as described in further detail below.

In the following descriptions, the term “gNB” is used for the base station/base unit, but it is replaceable by any other radio access node, e.g., RAN node, ng-eNB, eNB, Base Station (“BS”), Access Point (“AP”), NR BS, 5G NB, TRP, etc. Additionally, the term “UE” is used for the mobile station/remote unit, but it is replaceable by any other remote device, e.g., remote unit, MS, ME, etc. Further, the operations are described mainly in the context of 5G NR. However, the below described solutions/methods are also equally applicable to other mobile communication systems for CSI reporting prediction.

It should be understood that this disclosure uses the terms Channel State Information Reference Signal Resource Index (“CRI”), and Synchronization Signal/Physical Broadcast Channel Block Resource Index (“SSBRI”), and beam are used interchangeably. interchangeably.

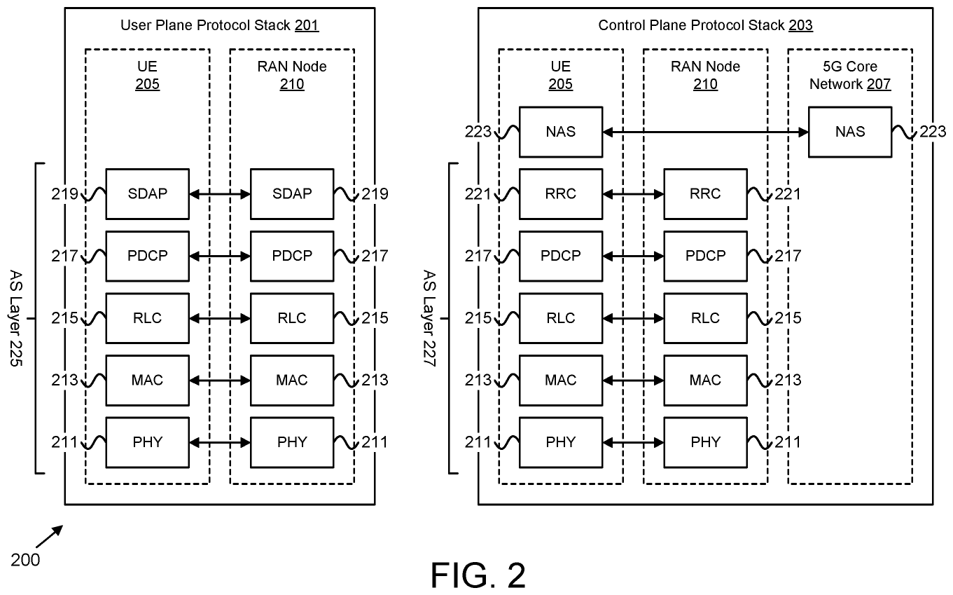

FIG. 2 depicts a NR protocol stack 200, according to embodiments of the disclosure. While FIG. 2 shows a UE 205, a RAN node 210 and the 5G core network 207, these are representative of a set of remote units 105 interacting with a base unit 121 and a mobile core network 140. As depicted, the protocol stack 200 comprises a User Plane protocol stack 201 and a Control Plane protocol stack 203. The User Plane protocol stack 201 includes a physical (“PHY”) layer 211, a Medium Access Control (“MAC”) sublayer 213, a Radio Link Control (“RLC”) sublayer 215, a Packet Data Convergence Protocol (“PDCP”) sublayer 217, and Service Data Adaptation Protocol (“SDAP”) layer 219. The Control Plane protocol stack 203 includes a physical layer 211, a MAC sublayer 213, a RLC sublayer 215, and a PDCP sublayer 217. The Control Place protocol stack 203 also includes a Radio Resource Control (“RRC”) layer 221 and a Non-Access Stratum (“NAS”) layer 223.

The AS layer 225 (also referred to as “AS protocol stack”) for the User Plane protocol stack 201 consists of at least SDAP, PDCP, RLC and MAC sublayers, and the physical layer. The AS layer 227 for the Control Plane protocol stack 203 consists of at least RRC, PDCP, RLC and MAC sublayers, and the physical layer. The Layer-2 (“L2”) is split into the SDAP, PDCP, RLC and MAC sublayers. The Layer-3 (“L3”) includes the RRC sublayer 221 and the NAS layer 223 for the control plane and includes, e.g., an Internet Protocol (“IP”) layer or PDU Layer (note depicted) for the user plane. L1 and L2 are referred to as “lower layers,” while L3 and above (e.g., transport layer, application layer) are referred to as “higher layers” or “upper layers.”

The physical layer 211 offers transport channels to the MAC sublayer 213. The MAC sublayer 213 offers logical channels to the RLC sublayer 215. The RLC sublayer 215 offers RLC channels to the PDCP sublayer 217. The PDCP sublayer 217 offers radio bearers to the SDAP sublayer 219 and/or RRC layer 221. The SDAP sublayer 219 offers QoS flows to the core network (e.g., 5GC). The RRC layer 221 provides for the addition, modification, and release of Carrier Aggregation (“CA”) and/or Dual Connectivity (“DC”). The RRC layer 221 also manages the establishment, configuration, maintenance, and release of Signaling Radio Bearers (“SRBs”) and Data Radio Bearers (“DRBs”).

The MAC layer 213 is the lowest sublayer in the Layer-2 architecture of the NR protocol stack. Its connection to the PHY layer 211 below is through transport channels, and the connection to the RLC layer 215 above is through logical channels. The MAC layer 213 therefore performs multiplexing and demultiplexing between logical channels and transport channels: the MAC layer 213 in the transmitting side constructs MAC PDUs, known as transport blocks, from MAC Service Data Units (“SDUs”) received through logical channels, and the MAC layer 213 in the receiving side recovers MAC SDUs from MAC PDUs received through transport channels.

The MAC layer 213 provides a data transfer service for the RLC layer 215 through logical channels, which are either control logical channels which carry control data (e.g., RRC signaling) or traffic logical channels which carry user plane data. On the other hand, the data from the MAC layer 213 is exchanged with the physical layer through transport channels, which are classified as downlink or uplink. Data is multiplexed into transport channels depending on how it is transmitted over the air.

The PHY layer 211 is responsible for the actual transmission of data and control information via the air interface, i.e., the PHY Layer 211 carries all information from the MAC transport channels over the air interface on the transmission side. Some of the important functions performed by the PHY layer 211 include coding and modulation, link adaptation (e.g., Adaptive Modulation and Coding (“AMC”)), power control, cell search (for initial synchronization and handover purposes) and other measurements (inside the 3GPP system (i.e., NR and/or LTE system) and between systems) for the RRC layer 221. The PHY layer 211 performs transmissions based on transmission parameters, such as the modulation scheme, the coding rate (i.e., the modulation and coding scheme (“MCS”)), the number of physical resource blocks etc.

Regarding beam-management in NR, beam management is defined as a set of Layer 1/2 procedures to acquire and maintain a set of beam pair links, i.e., a beam used at transmit-receive point(s) (TRP(s)) for BS side paired with a beam used at the UE 205. The beam pair links can be used for DL and UL transmission/reception. The set of Layer 1/2 beam management procedures include at least the following six aspects:
Beam sweeping: operation of covering a spatial area using multiple beams, with beams transmitted and/or received during a time interval in a predetermined way.
Beam measurement: where the TRP(s) or the UE 205 measures characteristics of received beamformed (“BF”) signals
Beam reporting: where the UE 205 reports information of BF signal(s) based on beam measurement
Beam determination: where the TRP(s) or the UE 205 selects of its own Tx/Rx beam(s)
Beam maintenance: where the TRP(s) or the UE 205 maintains the candidate beams by beam tracking or refinement to adapt to the channel changes due to blockage or to movement of the UE 205.
Beam recovery: where the UE 205 identifies new candidate beam(s) after detecting beam failure and subsequently inform TRP of beam recovery request with information of indicating the new candidate beam(s)

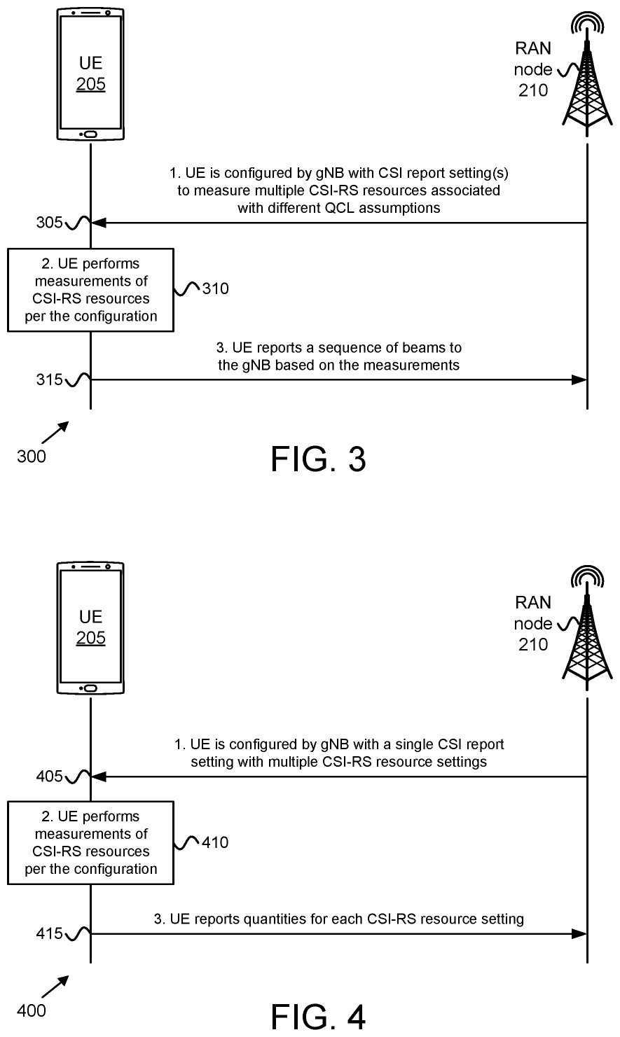

FIG. 3 depicts an exemplary procedure 300 for beams sequence and duration reporting, according to the first solution of the disclosure. The procedure 300 involves the UE 205 and the RAN node 210.

At Step 1, the RAN node 210 configures the UE 205 with one or more CSI report setting(s) to measure multiple CSI-RS resources associated with different Quasi-Co-Location (“QCL”) assumptions (see messaging 305).

At Step 2, the UE 205 performs measurements of CSI-RS resources according to the configuration (see block 310).

At Step 3, the UE 205 reports a sequence of beams to the RAN node 210 based on the performed measurements (see messaging 315).

According to embodiments of the first solution, the UE 205 is configured by network (i.e., RAN node 210) with CSI report setting(s) (e.g., in parameter CSI-ReportConfig) to measure beam quality on multiple CSI-RS resources associated with different QCL type-D assumptions (different beams) and report back a sequence of beams such as a sequence of CRI and/or SSBRI. In some embodiments, the UE 205 is additionally configured to report a corresponding duration for which each of the reported beams is valid/applicable.

In one implementation of the first solution, if a UE 205 is configured with a value for the number of CSI reports (or the number of CSI reference resources) in CSI-ReportConfig, e.g., included in higher layer parameter(s) sequentialTimeRestrictedChannelMeasurements and/or sequentialTimeRestrictedInterferenceMeasurements, then the UE 205 determines multiple CSI reference resources in the time domain for a CSI reporting in uplink slot n′ (e.g., multiple CSI reports corresponding to a sequence of time restricted CSI measurements are reported in one uplink slot) and the UE 205 derives each channel/interference measurement of a sequence of channel/interference measurements based on only the most recent, no later than each corresponding CSI reference resource of the multiple CSI reference resources.

In one example, the multiple CSI reference resources are defined by multiple downlink slots n−k·n_{CSI_ref}, k=M, M−1, M−2, M−3, . . . , 1, where M is the value for the number of CSI reference resources, where

$$n = ⌊ {n}^{′} \cdot \frac{{2}^{μ} DL}{{2}^{μ} UL} ⌋$$

and μ_{DL} and μ_{UL} are the subcarrier spacing configurations for DL and UL, respectively.

For periodic and semi-persistent CSI reporting, if a single CSI-RS and/or Synchronization Signal Block (“SSB”) resource is configured for channel measurement, then the value of n_{CSI_ref} is the smallest value greater than or equal to 4·2^{μ}^{_{DL}}, such that it corresponds to a valid downlink slot. Alternatively, if multiple CSI-RS/SSB resources are configured for channel measurement, then the value of n_{CSI_ref} is the smallest value greater than or equal to 5·2^{μ}^{_{DL}}, such that it corresponds to a valid downlink slot.

For aperiodic CSI reporting, the value of n_{CSI_ref} is the smallest value greater than or equal to └Z/N_{symb}^{slot}┘, such that slots n−k·n_{CSI_ref}, k=M, M−1, M−2, M−3, . . . , 1, correspond to valid downlink slots, where Z′ corresponds to the delay requirement, e.g., as defined in Clause 5.4 of 3GPP Technical Specification (“TS”) 38.214. Alternatively, where n_{CSI_ref} is configured via CSI-ReportConfig.

In certain embodiments of the first solution, the UE 205 is configured with a single CSI report setting (CSI-ReportConfig) with multiple CSI resource settings (CSI-ResourceConfig) to measure beam quality on multiple CSI-RS resources associated with different QCL type-D assumptions (different beams) and report back a sequence of beams such as a sequence of CRI/SSBRI and corresponding duration for which each of the reported beams is valid/applicable. In one implementation, the CSI reporting quantity associated with reporting a sequence of beams is “cri-sequence-RSRP” or “ssb-Index-sequence-RSRP” i.e., when the UE 205 is configured to report such quantity, then the UE 205 is expected to report a sequence of beams. Here, the number of beams to be included in the sequence may configured to the UE 205 with CSI report setting.

In some embodiments of the first solution, the CSI reporting quantity “cri-sequence-RSRP” or “ssb-Index-sequence-RSRP” is associated with additional reporting quantity to indicate the duration for which each of the indicated CRI/SSBRI within a sequence is valid. In one implementation, the indicated duration for the first CRI/SSBRI (i.e., first beam) is applicable from the time the reporting is received by gNB and the following CRIs are the applied duration from the end of applicability of previous CRI. For example, if duration for second CRI is 4 ms, then the second CRI is applicable for 4 ms starting as soon as the first CRI applicability expires, following which third CRI becomes applicable. In some embodiments, a separate duration is reported for each of the CRI/SSBRI. In alternate embodiments, a single duration is reported which is applicable for each CRI/SSBRI.

In alternate embodiments of the first solution, the UE 205 is configured with multiple CSI report settings, where each report setting is associated with a single channel/interference measurement resource setting. Corresponding to each CSI report setting, at least one best beam is reported, i.e., CRI/SSBRI and corresponding duration for which the reported beam is applicable. In one implementation, the CSI reporting quantity associated with reporting a sequence of beams (e.g., parameter “cri-duration-RSRP” or “ssb-Index-duration-RSRP”) is used to indicate the duration for which each of the indicated CRI/SSBRI is valid.

In some embodiments of the first solution, the UE 205 is configured to report one actual CRI value within the sequence, while a differential value of the CRI (relative to one actual value) is reported for all the other CRIs within the sequence.

In some embodiments of the first solution, the UE 205 is configured to report one CRI value, number of CRIs and duration of a CRI value, where the following CRI values can be determined in a sequential order. For example, if the one CRI value reported is ‘CRI1’ and if 4 CRIs are expected in the sequence and if reported duration is 2 slots for each CRI value, then the gNB determines that CRI1 is applicable for first 2 slots, CRI2 for next 2 slots, CRI3 for next 2 slots and CRI4 for last 2 slots.

FIG. 4 depicts an exemplary procedure 400 for CSI reporting for reported sequence of beams, according to the second solution of the disclosure. The procedure 400 involves the UE 205 and the RAN node 210.

At Step 1, the RAN node 210 configures the UE 205 with a single CSI report setting with multiple CSI-RS resources settings (see messaging 405).

At Step 2, the UE 205 performs measurements of CSI-RS resources according to the configuration (see block 410).

At Step 3, the UE 205 reports quantities to the RAN node 210 for each CSI-RS setting (see messaging 415).

According to embodiments of the second solution, the UE 205 is configured by network with single CSI report setting with multiple CSI-RS resource settings, where each of the resource settings is associated with the CRI sequence reported by the UE 205 and the reporting quantities for each of the resources settings (beams) related to channel measurements can be ‘RI-PMI-CQI’ or ‘RI-i1’ or ‘RI-i1-CQI’ or ‘RI-CQI’ or ‘RSRP’ or ‘ SINR’ or difference in CQI relative to previous reported value. These report quantities may be as defined in 3GPP TS 38.214.

In alternate embodiments of the second solution, the UE 205 is configured by network with single CSI report setting with single CSI-RS resource setting, where the QCL type-D assumption associated with CSI resources is based on reported CRI sequence that is varying in time (according to the duration of CRI applicability reported by the UE 205) and based on the varying CRI, the UE 205 can report ‘RI-PMI-CQI’ or ‘RI-i1’ or ‘RI-i1-CQI’ or ‘RI-CQI’ or ‘RSRP’ or ‘SINR’ or difference in CQI relative to previous reported value for each of the CRI within the sequence. In one implementation, the UE 205 reports individual quantities for each of the CRI.

In other implementations, the UE 205 can report single set of quantities for all the CRIs. In alternate implementations, the UE 205 can report a sub-set of quantities individually for each of the CRIs and a sub-set of quantities common across all the CRIs. In some embodiments, the UE 205 reports the actual quantity value such as CQI value only for one CRI, while it reports differential value for all other CRIs relative to the one CRI for which the actual quantity value is reported.

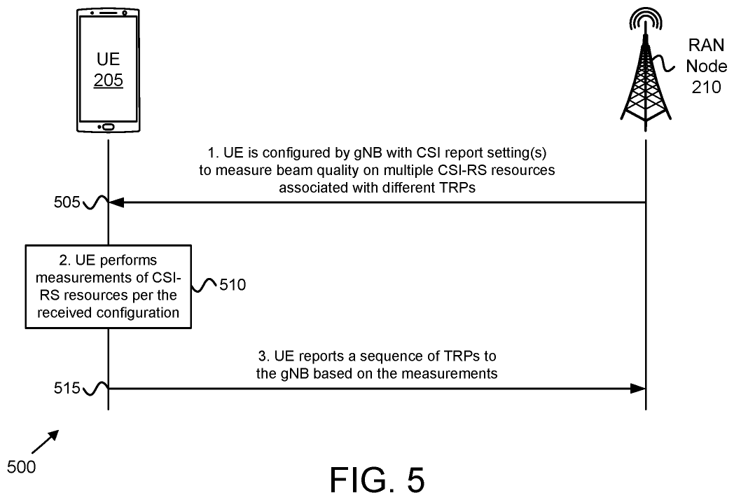

FIG. 5 depicts an exemplary procedure 500 for TRP sequence, duration, and CSI reporting, according to the third solution of the disclosure. The procedure 500 involves the UE 205 and the RAN node 210.

At Step 1, the RAN node 210 configures the UE 205 with one or more CSI report setting(s) to measure beam quality on multiple CSI-RS resources associated with different TRPs (see messaging 505).

At Step 2, the UE 205 performs measurements of CSI-RS resources according to the configuration (see block 510).

At Step 3, the UE 205 reports a sequence of TRPs to the RAN node 210 based on the performed measurements (see messaging 515).

According to embodiments of the third solution, the UE 205 is configured by network with CSI report setting(s) to measure beam quality on multiple CSI-RS resources associated with different TRPs and report back a sequence of TRPs, i.e., CRI and/or SSBRI associated with TRPs and corresponding duration for which each of the reported TRPs is valid.

In some embodiments of the third solution, the UE 205 is configured with a single CSI report setting with multiple channel measurement resource settings and/or multiple interference measurement resource settings, where each of the CSI (i.e., channel/interference measurements) resource setting is associated with a TRP or a set of TRPs (or a Control Resource Set (“CORESET”) pool index). In one implementation the CSI reporting quantity associated with reporting a sequence of TRPs (or a sequence of sets of TRPs) is “cri-sequence-RSRP” or “ssb-Index-sequence-RSRP.” In some embodiments, CSI reporting quantity “cri-sequence-RSRP” or “ssb-Index-sequence-RSRP” is associated with additional reporting quantity to indicate the duration for which each of the indicated TRP within a sequence is valid. In some embodiments, a separate duration is reported for each of the TRP. In alternate embodiments, a single duration is reported which is applicable for each TRP.

In alternate embodiments of the third solution, the UE 205 is configured with multiple CSI report settings, where each report setting is associated with a single channel/interference measurement resource setting, e.g., a CSI resource setting corresponding to a TRP or a set of TRPs. Corresponding to each CSI report setting, at least one best beam/TRP is reported, i.e., CRI/SSBRI and corresponding duration for which the reported TRP is applicable. In one implementation the CSI reporting quantity associated with reporting a sequence of TRPs is “cri-duration-RSRP” or “ssb-Index-duration-RSRP.”

In some embodiments of the third solution, the UE 205 is configured by network with single CSI report setting with multiple CSI-RS resource settings, where each of the resource settings is associated a TRP (based on CORESETPoolIndex or some other Identifier (“ID”) for a TRP). The reporting quantities for each of the resources settings (TRPs) related to channel measurements can be ‘RI-PMI-CQI’ or ‘RI-i1’ or ‘RI-i1-CQI’ or ‘RI-CQI’ or ‘RSRP’ or ‘SINR’ or difference in CQI relative to previous reported value.

In alternate embodiments of the third solution, the UE 205 is configured by network with single CSI report setting with single CSI-RS resource setting, where the TRP associated with CSI resources is based on reported TRP sequence that is varying in time (according to the duration of TRP applicability reported by the UE 205) and based on the varying TRP, the UE 205 can report ‘RI-PMI-CQI’ or ‘RI-i1’ or ‘RI-i1-CQI’ or ‘RI-CQI’ or ‘RSRP’ or ‘SINR’ or difference in CQI relative to previous reported value for each of the TRP within the sequence.

In one implementation, the UE 205 reports individual quantities for each of the TRP. In other implementations, the UE 205 can report single set of quantities for all the TRPs. In alternate implementations, the UE 205 can report a sub-set of quantities individually for each of the TRPs and a sub-set of quantities common across all the TRPs. In some embodiments, the UE 205 reports the actual quantity value such as CQI value only for one TRP, while it reports differential value for all other TRPs relative to the one TRP for which the actual quantity value is reported.

Regarding UL beam-management in NR, according to 3GPP TS 38.214, two transmission schemes, codebook-based transmissions and non-codebook based transmissions, are supported for PUSCH. For PUSCH transmission(s) dynamically scheduled by an UL grant in a Downlink Control Information (“DCI”), a UE shall upon detection of a PDCCH with a configured DCI format 0_0 or 0_1 transmit the corresponding PUSCH as indicated by that DCI.

For PUSCH scheduled by DCI format 0_0 on a cell, the UE shall transmit PUSCH according to the spatial relation, if applicable, corresponding to the physical uplink control channel (“PUCCH”) resource with the lowest identity (“ID”) within the active UL Bandwidth Part (“BWP”) of the cell, and the PUSCH transmission is based on a single antenna port. A spatial setting for a PUCCH transmission is provided by higher layer parameter PUCCH-SpatialRelationInfo if the UE is configured with a single value for higher layer parameter pucch-SpatialRelationInfoId; otherwise, if the UE is provided multiple values for higher layer parameter PUCCH-SpatialRelationInfo, the UE determines a spatial setting for the PUCCH transmission based on a received PUCCH spatial relation activation/deactivation MAC Control Element (“CE”) as described in 3GPP TS 38.321. The UE applies a corresponding setting for a spatial domain filter to transmit PUCCH 3 msec after the slot where the UE transmits Hybrid Automatic Repeat Request acknowledgement (“HARQ-ACK”) information with ACK value corresponding to a PDSCH reception providing the PUCCH-SpatialRelationInfo. As used herein, “HARQ-ACK” may represent collectively the Positive Acknowledge (“ACK”) and the Negative Acknowledge (“NACK”). ACK means that a Transport Block (“TB”) is correctly received while NACK (or NAK) means a TB is erroneously received.

For codebook-based transmission, PUSCH can be scheduled by DCI format 0_0 or DCI format 0_1. If a PUSCH is scheduled by DCI format 0_1, the UE determines its PUSCH transmission precoder based on Sounding Reference Signal Resource Indicator (“SRI”), Transmit Precoding Matrix Indicator (“TPMI”) and the transmission rank from the DCI, given by DCI fields of Sounding Reference Signal (“SRS”) resource indicator and Precoding information and number of layers in subclause 7.3.1.1.2 of 3GPP TS 38.212. The TPMI is used to indicate the precoder to be applied over the antenna ports {0 . . . ν−1} and that corresponds to the SRS resource selected by the SRI (unless a single SRS resource is configured for a single SRS-ResourceSet set to ‘codebook’).

The transmission precoder is selected from the uplink codebook that has a number of antenna ports equal to higher layer parameter nroJSRS-Ports in SRS-Config, as defined in Subclause 6.3.1.5 of 3GPP TS 38.211. When the UE is configured with the higher layer parameter txConfig set to ‘codebook,’ the UE is configured with at least one SRS resource. The indicated SRI in slot n is associated with the most recent transmission of SRS resource identified by the SRI, where the SRS resource is prior to the PDCCH carrying the SRI before slot n.

The UE determines its codebook subsets based on TPMI and upon the reception of higher layer parameter codebookSubset in PUSCH-Config which may be configured with ‘fullyAndPartialAndNonCoherent,’ or ‘partialAndNonCoherent,’ or ‘nonCoherent’ depending on the UE capability. The maximum transmission rank may be configured by the higher parameter maxRank in PUSCH-Config.

For non-codebook based transmission, PUSCH can be scheduled by DCI format 0_0 or DCI format 0_1. The UE can determine its PUSCH precoder and transmission rank based on the wideband SRI when multiple SRS resources are configured in an SRS resource set with higher layer parameter usage in SRS-ResourceSet set to ‘nonCodebook,’ where the SRI is given by the SRS resource indicator in DCI format 0_1 according to subclause 7.3.1.1.2 of 3GPP TS 38.212 and only one SRS port is configured for each SRS resource. The indicated SRI in slot n is associated with the most recent transmission of SRS resource(s) identified by the SRI, where the SRS transmission is prior to the PDCCH carrying the SRI before slot n.

The UE shall perform one-to-one mapping from the indicated SRI(s) to the indicated Demodulation Reference Signal (“DM-RS”) ports(s) given by DCI format 0_1 in increasing order.

In 3GPP NR Release 16 (“Rel-16”), for PUSCH scheduled by DCI format 0_0 on a cell and if the higher layer parameter enableDefaultBeamPlForPUSCH0_0 is set ‘enabled,’ the UE is not configured with PUCCH resources on the active UL BWP and the UE is in RRC connected mode, the UE shall transmit PUSCH according to the spatial relation, if applicable, with a reference to the Reference Signal (“RS”) with ‘QCL-Type-D’ corresponding to the QCL assumption of the CORESET with the lowest ID. For PUSCH scheduled by DCI format 0_0 on a cell and if the higher layer parameter enableDefaultBeamPlForPUSCH0_0 is set ‘enabled,’ the UE is configured with PUCCH resources on the active UL BWP where all the PUCCH resource(s) are not configured with any spatial relation and the UE is in RRC connected mode, the UE shall transmit PUSCH according to the spatial relation, if applicable, with a reference to the RS with ‘QCL-Type-D’ corresponding to the QCL assumption of the CORESET with the lowest ID in case CORESET(s) are configured on the Component Carrier (“CC”).

According to 3GPP Rel-16 TS 38.214, Rel-16 NR supports a MAC CE based spatial relation update for aperiodic SRS per resource level and a default UL beam for an SRS resource for latency and overhead reduction in UL beam management.

Regarding DL beam-management in NR, one possibility to handling CSI reporting feedback for beam management is to use group-based beam reporting. However, due to no association with TRPs, the benefit is only limited to reduce overhead from feedback point of view and TRP-based beam management cannot benefit much. According to section 5.2.1.4 of 3GPP TS 38.214 (v16.0.0), following is specified in terms of CSI reporting:

If the UE is configured with a CSI-ReportConfig with the higher layer parameter reportQuantity set to ‘cri-RSRP’ or ‘ssb-Index-RSRP,’ then if the UE is configured with the higher layer parameter groupBasedBeamReporting set to ‘disabled,’ the UE is not required to update measurements for more than 64 CSI-RS and/or SSB resources, and the UE shall report in a single report nrofReportedRS (higher layer configured) different CRI or SSBRI for each report setting. Otherwise, if the UE is configured with the higher layer parameter groupBasedBeamReporting set to ‘enabled,’ the UE is not required to update measurements for more than 64 CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.

If the UE is configured with a CSI-ReportConfig with the higher layer parameter reportQuantity set to ‘cri-SINR’ or ‘ssb-Index-SINR,’ then if the UE is configured with the higher layer parameter groupBasedBeamReporting set to ‘disabled,’ the UE shall report (i.e., in a single report) nrofReportedRSForSINR (higher layer configured) different CRI or SSBRI for each report setting. Otherwise, if the UE is configured with the higher layer parameter groupBasedBeamReporting set to ‘enabled,’ the UE shall report in a single reporting instance two different CRI or SSBRI for each report setting, (i.e., where CSI-RS and/or SSB resources can be received simultaneously by the UE either with a single spatial domain receive filter, or with multiple simultaneous spatial domain receive filters).

Regarding QCL assumptions, according to current specification, there is only one QCL type, i.e., qcl-typeD for spatial relation between the source RS and target RS. This means that only a single source to single target beam association can be established. However, as we go higher in frequency, the number of beams could become a lot higher, therefore, more coarse association could be considered to cover wider areas. Also, from Transmission Configuration Indicator (“TCI”) indication point of view, there was enhancement in Rel. 16 to indicate up to two TCI states corresponding to two TRPs. However, this is still quite limited when there could be possibly higher number of TRPs for Frequency Range #2 (“FR2,” i.e., frequencies from 24.25 GHz to 52.6 GHz) and beyond. According to section 5.1.5 of 3GPP TS 38.214 (v16.0.0), following is specified in terms of QCL assumptions:

The UE can be configured with a list of up to M TCI-State configurations within the higher layer parameter PDSCH-Config to decode PDSCH according to a detected PDCCH with DCI intended for the UE and the given serving cell, where M depends on the UE capability maxNumberConfiguredTCIstatesPerCC. Each TCI-State contains parameters for configuring a quasi-co-location relationship between one or two downlink reference signals and the DM-RS ports of the PDSCH, the DM-RS port of PDCCH or the CSI-RS port(s) of a CSI-RS resource. The quasi co-location relationship is configured by the higher layer parameter qcl-Type1 for the first DL RS, and qcl-Type2 for the second DL RS (if configured). For the case of two DL RSs, the QCL types shall not be the same, regardless of whether the references are to the same DL RS or different DL RSs. The quasi co-location types corresponding to each DL RS are given by the higher layer parameter qcl-Type in QCL-Info and may take one of the following values: 1) ‘QCL-TypeA’: {Doppler shift, Doppler spread, average delay, delay spread}; 2) ‘QCL-TypeB’: {Doppler shift, Doppler spread}; 3) ‘QCL-TypeC’: {Doppler shift, average delay}; 4) ‘QCL-TypeD’: {Spatial Rx parameter}.

The UE receives an activation command, e.g., as described in clause 6.1.3.14 of 3GPP TS 38.321, used to map up to 8 TCI states to the codepoints of the DCI field ‘Transmission Configuration Indication’ in one CC/DL BWP or in a set of CCs/DL BWPs, respectively. When a set of TCI state IDs are activated for a set of CCs/DL BWPs, where the applicable list of CCs is determined by indicated CC in the activation command, the same set of TCI state IDs are applied for all DL BWPs in the indicated CCs.

When a UE supports two TCI states in a codepoint of the DCI field ‘Transmission Configuration Indication’ the UE may receive an activation command, as described in clause of 3GPP TS 38.321, the activation command is used to map up to 8 combinations of one or two TCI states to the codepoints of the DCI field ‘Transmission Configuration Indication.’ The UE is not expected to receive more than 8 TCI states in the activation command.

When the UE would transmit a PUCCH with HARQ-ACK information in slot n corresponding to the PDSCH carrying the activation command, the indicated mapping between TCI states and codepoints of the DCI field ‘Transmission Configuration Indication’ should be applied starting from the first slot that is after slot n+3Nₛₗₒₜ^{subframe,μ} where μ is the Subcarrier Spacing (“SCS”) configuration for the PUCCH. If tci-PresentInDCI is set to “enabled” or tci-PresentInDCI-ForFormat1_2 is configured for the CORESET scheduling the PDSCH, and the time offset between the reception of the DL DCI and the corresponding PDSCH is equal to or greater than timeDurationForQCL if applicable, after a UE receives an initial higher layer configuration of TCI states and before reception of the activation command, the UE may assume that the DM-RS ports of PDSCH of a serving cell are quasi co-located with the Synchronization Signal/Physical Broadcast Channel (“SS/PBCH”) block determined in the initial access procedure with respect to ‘QCL-TypeA,’ and when applicable, also with respect to ‘QCL-TypeD.’

If a UE is configured with the higher layer parameter tci-PresentInDCI that is set as ‘enabled’ for the CORESET scheduling the PDSCH, the UE assumes that the TCI field is present in the DCI format 1_1 of the PDCCH transmitted on the CORESET. If a UE is configured with the higher layer parameter tci-PresentInDCI-ForFormat1_2 for the CORESET scheduling the PDSCH, the UE assumes that the TCI field with a DCI field size indicated by tci-PresentInDCI-ForFormat1_2 is present in the DCI format 1_2 of the PDCCH transmitted on the CORESET. If the PDSCH is scheduled by a DCI format not having the TCI field present, and the time offset between the reception of the DL DCI and the corresponding PDSCH is equal to or greater than a threshold timeDurationForQCL if applicable, where the threshold is based on reported UE capability 3GPP TS 38.306, for determining PDSCH antenna port quasi co-location, the UE assumes that the TCI state or the QCL assumption for the PDSCH is identical to the TCI state or QCL assumption whichever is applied for the CORESET used for the PDCCH transmission.

If the PDSCH is scheduled by a DCI format having the TCI field present, the TCI field in DCI in the scheduling component carrier points to the activated TCI states in the scheduled component carrier or DL BWP, the UE shall use the TCI-State according to the value of the ‘Transmission Configuration Indication’ field in the detected PDCCH with DCI for determining PDSCH antenna port quasi co-location. The UE may assume that the DM-RS ports of PDSCH of a serving cell are quasi co-located with the RS(s) in the TCI state with respect to the QCL type parameter(s) given by the indicated TCI state if the time offset between the reception of the DL DCI and the corresponding PDSCH is equal to or greater than a threshold timeDurationForQCL, where the threshold is based on reported UE capability 3GPP TS 38.306.

When the UE is configured with a single slot PDSCH, the indicated TCI state should be based on the activated TCI states in the slot with the scheduled PDSCH. When the UE is configured with a multi-slot PDSCH, the indicated TCI state should be based on the activated TCI states in the first slot with the scheduled PDSCH, and UE shall expect the activated TCI states are the same across the slots with the scheduled PDSCH. When the UE is configured with CORESET associated with a search space set for cross-carrier scheduling, and the PDCCH carrying the scheduling DCI and the PDSCH scheduled by that DCI are transmitted on the same carrier, the UE expects tci-PresentInDCI is set as ‘enabled’ or tci-PresentInDCI-ForFormat1_2 is configured for the CORESET, and if one or more of the TCI states configured for the serving cell scheduled by the search space set contains ‘QCL-TypeD,’ the UE expects the time offset between the reception of the detected PDCCH in the search space set and the corresponding PDSCH is larger than or equal to the threshold timeDurationForQCL.

Independent of the configuration of tci-PresentInDCI and tci-PresentInDCI-ForFormat1_2 in RRC connected mode, if all the TCI codepoints are mapped to a single TCI state and the offset between the reception of the DL DCI and the corresponding PDSCH is less than the threshold timeDurationForQCL, the UE may assume that the DM-RS ports of PDSCH of a serving cell are quasi co-located with the RS(s) with respect to the QCL parameter(s) used for PDCCH quasi co-location indication of the CORESET associated with a monitored search space with the lowest controlResourceSetld in the latest slot in which one or more CORESETs within the active BWP of the serving cell are monitored by the UE.

In this case, if the ‘QCL-TypeD’ of the PDSCH DM-RS is different from that of the PDCCH DM-RS with which they overlap in at least one symbol, the UE is expected to prioritize the reception of PDCCH associated with that CORESET. This also applies to the intra-band CA case (when PDSCH and the CORESET are in different component carriers). If none of configured TCI states for the serving cell of scheduled PDSCH contains ‘QCL-TypeD,’ the UE shall obtain the other QCL assumptions from the indicated TCI states for its scheduled PDSCH irrespective of the time offset between the reception of the DL DCI and the corresponding PDSCH.

If a UE configured by higher layer parameter PDCCH-Config that contains two different values of CORESETPoolIndex in ControlResourceSet, for both cases, when tci-PresentInDCI is set to ‘enabled’ and tci-PresentInDCI is not configured in RRC connected mode, if the offset between the reception of the DL DCI and the corresponding PDSCH is less than the threshold timeDurationForQCL, the UE may assume that the DM-RS ports of PDSCH associated with a value of CORESETPoolIndex of a serving cell are quasi co-located with the RS(s) with respect to the QCL parameter(s) used for PDCCH quasi co-location indication of the CORESET associated with a monitored search space with the lowest CORESET-ID among CORESETs, which are configured with the same value of CORESETPoolIndex as the PDCCH scheduling that PDSCH, in the latest slot in which one or more CORESETs associated with the same value of CORESETPoolIndex as the PDCCH scheduling that PDSCH within the active BWP of the serving cell are monitored by the UE.

If the offset between the reception of the DL DCI and the corresponding PDSCH is less than the threshold timeDurationForQCL and at least one configured TCI states for the serving cell of scheduled PDSCH contains the ‘QCL-TypeD,’ and at least one TCI codepoint indicates two TCI states, the UE may assume that the DM-RS ports of PDSCH of a serving cell are quasi co-located with the RS(s) with respect to the QCL parameter(s) associated with the TCI states corresponding to the lowest codepoint among the TCI codepoints containing two different TCI states.

If the PDCCH carrying the scheduling DCI is received on one component carrier, and the PDSCH scheduled by that DCI is on another component carrier, then the timeDurationForQCL is determined based on the subcarrier spacing of the scheduled PDSCH. If μ_{PDCCH}<μ_{PDSCH} an additional timing delay d is added to the timeDurationForQCL, where d is defined in 5.2.1.5.1a-1.

For both the cases when tci-PresentInDCI is set to ‘enabled’ and the offset between the reception of the DL DCI and the corresponding PDSCH is less than the threshold timeDurationForQCL and when tci-PresentInDCI is not configured, the UE obtains its QCL assumption for the scheduled PDSCH from the activated TCI state with the lowest ID applicable to PDSCH in the active BWP of the scheduled cell.

For a periodic non-zero power (“NZP”) CSI-RS resource in an NZP-CSI-RS-ResourceSet configured with higher layer parameter trs-Info, the UE shall expect that a TCI-State indicates one of the following quasi co-location type(s): 1) ‘QCL-TypeC’ with an SS/PBCH block and, when applicable, ‘QCL-TypeD’ with the same SS/PBCH block, or 2) ‘QCL-TypeC’ with an SS/PBCH block and, when applicable, ‘QCL-TypeD’ with a CSI-RS resource in an NZP-CSI-RS-ResourceSet configured with higher layer parameter repetition.

For an aperiodic CSI-RS resource in an NZP-CSI-RS-Resource Set configured with higher layer parameter trs-Info, the UE shall expect that a TCI-State indicates ‘QCL-TypeA’ with a periodic CSI-RS resource in an NZP-CSI-RS-ResourceSet configured with higher layer parameter trs-Info and, when applicable, ‘QCL-TypeD’ with the same periodic CSI-RS resource.

For a CSI-RS resource in an NZP-CSI-RS-ResourceSet configured without higher layer parameter trs-Info and without the higher layer parameter repetition, the UE shall expect that a TCI-State indicates one of the following quasi co-location type(s): 1) ‘QCL-TypeA’ with a CSI-RS resource in an NZP-CSI-RS-ResourceSet configured with higher layer parameter trs-Info and, when applicable, ‘QCL-TypeD’ with the same CSI-RS resource, or 2) ‘QCL-TypeA’ with a CSI-RS resource in an NZP-CSI-RS-ResourceSet configured with higher layer parameter trs-Info and, when applicable, ‘QCL-TypeD’ with an SS/PBCH block, or 3) ‘QCL-TypeA’ with a CSI-RS resource in an NZP-CSI-RS-ResourceSet configured with higher layer parameter trs-Info and, when applicable, ‘QCL-TypeD’ with a CSI-RS resource in an NZP-CSI-RS-ResourceSet configured with higher layer parameter repetition, or 4) ‘QCL-TypeB’ with a CSI-RS resource in an NZP-CSI-RS-Resource Set configured with higher layer parameter trs-Info when ‘QCL-TypeD’ is not applicable.

For a CSI-RS resource in an NZP-CSI-RS-ResourceSet configured with higher layer parameter repetition, the UE shall expect that a TCI-State indicates one of the following quasi co-location type(s): 1) ‘QCL-TypeA’ with a CSI-RS resource in an NZP-CSI-RS-ResourceSet configured with higher layer parameter trs-Info and, when applicable, ‘QCL-TypeD’ with the same CSI-RS resource, or 2) ‘QCL-TypeA’ with a CSI-RS resource in an NZP-CSI-RS-ResourceSet configured with higher layer parameter trs-Info and, when applicable, ‘QCL-TypeD’ with a CSI-RS resource in an NZP-CSI-RS-ResourceSet configured with higher layer parameter repetition, or 3) ‘QCL-TypeC’ with an SS/PBCH block and, when applicable, ‘QCL-TypeD’ with the same SS/PBCH block.

For the DM-RS of PDCCH, the UE shall expect that a TCI-State indicates one of the following quasi co-location type(s): 1) ‘QCL-TypeA’ with a CSI-RS resource in an NZP-CSI-RS-ResourceSet configured with higher layer parameter trs-Info and, when applicable, ‘QCL-TypeD’ with the same CSI-RS resource, or 2) ‘QCL-TypeA’ with a CSI-RS resource in an NZP-CSI-RS-ResourceSet configured with higher layer parameter trs-Info and, when applicable, ‘QCL-TypeD’ with a CSI-RS resource in an NZP-CSI-RS-ResourceSet configured with higher layer parameter repetition, or 3) ‘QCL-TypeA’ with a CSI-RS resource in an NZP-CSI-RS-ResourceSet configured without higher layer parameter trs-Info and without higher layer parameter repetition and, when applicable, ‘QCL-TypeD’ with the same CSI-RS resource.

For the DM-RS of PDSCH, the UE shall expect that a TCI-State indicates one of the following quasi co-location type(s): 1) ‘QCL-TypeA’ with a CSI-RS resource in an NZP-CSI-RS-ResourceSet configured with higher layer parameter trs-Info and, when applicable, ‘QCL-TypeD’ with the same CSI-RS resource, or 2) ‘QCL-TypeA’ with a CSI-RS resource in an NZP-CSI-RS-ResourceSet configured with higher layer parameter trs-Info and, when applicable, ‘QCL-TypeD’ with a CSI-RS resource in an NZP-CSI-RS-ResourceSet configured with higher layer parameter repetition, or 3) QCL-TypeA’ with a CSI-RS resource in an NZP-CSI-RS-ResourceSet configured without higher layer parameter trs-Info and without higher layer parameter repetition and, when applicable, ‘QCL-TypeD’ with the same CSI-RS resource.

Regarding reporting configuration, the UE shall calculate CSI parameters (if reported) assuming the following dependencies between CSI parameters (if reported): A) LI shall be calculated conditioned on the reported CQI, PMI, RI and CRI; B) CQI shall be calculated conditioned on the reported PMI, RI and CRI; C) PMI shall be calculated conditioned on the reported RI and CRI; D) RI shall be calculated conditioned on the reported CRI. These reporting parameters and their dependencies are defined in 3GPP TS 38.214.

The Reporting configuration for CSI can be aperiodic (using PUSCH), periodic (using PUCCH) or semi-persistent (using PUCCH, and DCI activated PUSCH). The CSI-RS Resources can be periodic, semi-persistent, or aperiodic. Table 1 shows the supported combinations of CSI Reporting configurations and CSI-RS Resource configurations and how the CSI Reporting is triggered for each CSI-RS Resource configuration. Periodic CSI-RS is configured by higher layers. Table 1 is derived from Table 5.2.1.4-1 in 3GPP TS 38.214 (v16.0.0). Semi-persistent CSI-RS is activated and deactivated as described in Clause 5.2.1.5.2 of 3GPP TS 38.214 (v16.0.0). Aperiodic CSI-RS is configured and triggered/activated as described in Clause 5.2.1.5.1 of 3GPP TS 38.214 (v16.0.0).

TABLE 1
Triggering/Activation of CSI Reporting for the possible CSI-RS Configurations.

| | Periodic CSI | Semi-Persistent CSI | Aperiodic CSI |
|---|---|---|---|
| CSI-RS Configuration | Reporting | Reporting | Reporting |
| Periodic CSI-RS | No dynamic | For reporting on | Triggered by DCI; |
| | triggering/activation | PUCCH, the UE | additionally, sub- |
| | | receives an activation | selection indication |
| | | command, (e.g., as | (e.g., as described in |
| | | described in clause | clause 6.1.3.13 of |
| | | 6.1.3.13 of 3GPP TS | 3GPP TS 38.321, |
| | | 38.321); for reporting | possible as defined in |
| | | on PUSCH, the UE | Clause 5.2.1.5.1 of |
| | | receives triggering on | 3GPP TS 38.214 |
| | | DCI | v16.0.0). |
| Semi-Persistent CSI-RS | Not Supported | For reporting on | Triggered by DCI; |
| | | PUCCH, the UE | additionally, sub- |
| | | receives an activation | selection indication |
| | | command, (e.g., as | (e.g., as described in |
| | | described in clause | clause 6.1.3.13 of |
| | | 6.1.3.13 of 3GPP TS | 3GPP TS 38.321, |
| | | 38.321); for reporting | possible as defined in |
| | | on PUSCH, the UE | Clause 5.2.1.5.1 of |
| | | receives triggering on | 3GPP TS 38.214 |
| | | DCI | v16.0.0). |
| Aperiodic CSI-RS | Not Supported | Not Supported | Triggered by DCI; |
| | | | additionally, sub- |
| | | | selection indication |
| | | | (e.g., as described in |
| | | | clause 6.1.3.13 of |
| | | | 3GPP TS 38.321, |
| | | | possible as defined in |
| | | | Clause 5.2.1.5.1 of |
| | | | 3 GPP TS 38.214 |
| | | | v16.0.0). |

When the UE is configured with higher layer parameter NZP-CSI-RS-ResourceSet and when the higher layer parameter repetition is set to ‘off,’ the UE shall determine a CRI from the supported set of CRI values (e.g., as defined in Clause 6.3.1.1.2 of 3GPP TS 38.212) and report the number in each CRI report. When the higher layer parameter repetition is set to ‘on,’ CRI is not reported. CRI reporting is not supported when the higher layer parameter codebookType is set to either ‘typeII,’ ‘typeII-PortSelection,’ ‘typeII-r16’ or to ‘typeII-PortSelection-r16.’

For a periodic or semi-persistent CSI report on PUCCH, the periodicity T_{CSI} (measured in slots) and the slot offset T_{offset} are configured by the higher layer parameter reportSlotConfig. Unless specified otherwise, the UE shall transmit the CSI report in frames with System Frame Number (“SFN”) n_{f} and slot number within the frame n_{s,f}^{μ} satisfying

(Nₛₗₒₜ^{frame,μ}n_{f}+n_{s,f}^{μ}−T_{offset})mod T_{CSI}=0

where μ is the SCS configuration of the UL BWP the CSI report is transmitted on.

For a semi-persistent CSI report on PUSCH, the periodicity T_{CSI} (measured in slots) is configured by the higher layer parameter reportSlotConfig. Unless specified otherwise, the UE shall transmit the CSI report in frames with SFN n_{f} and slot number within the frame n_{s,f}^{μ} satisfying

(Nₛₗₒₜ^{frame,μ}(n_{f}−n_{f}^{start})+n_{s,f}^{μ}−n_{s,f}^{start})mod T_{CSI}=0

where n_{f}^{start} and n_{s,f}^{start} are the SFN and slot number within the frame respectively of the initial semi-persistent PUSCH transmission according to the activating DCI.

For a semi-persistent or aperiodic CSI report on PUSCH, the allowed slot offsets are configured by the following higher layer parameters: if triggered/activated by DCI format 0_2 and the higher layer parameter reportSlotOffsetListDCI-0-2 is configured, the allowed slot offsets are configured by reportSlotOffsetListDCI-0-2, and if triggered/activated by DCI format 0_1 and the higher layer parameter reportSlotOffsetListDCI-0-1 is configured, the allowed slot offsets are configured by reportSlotOffsetListDCI-0-1, and otherwise, the allowed slot offsets are configured by the higher layer parameter reportSlotOffsetList. The offset is selected in the activating/triggering DCI.

For CSI reporting, a UE can be configured via higher layer signaling with one out of two possible subband sizes, where a subband (“SB”) is defined as N_{PRB}^{SB} contiguous Physical Resource Blocks (“PRBs”) and depends on the total number of PRBs in the bandwidth part according to Table 2, below. The values in Table 2 are derived from 3GPP TS 38.214 (v16.0.0) Table 5.2.1.4-2.

TABLE 2
Configurable subband sizes

| Bandwidth part (PRBs) | Subband size (PRBs) |
|---|---|
| 24-72 | 4, 8 |
| 73-144 | 8, 16 |
| 145-275 | 16, 32 |

The reportFreqConfiguration contained in a CSI-ReportConfig indicates the frequency granularity of the CSI Report. A CSI Reporting Setting configuration defines a CSI reporting band as a subset of subbands of the bandwidth part, where the reportFreqConfiguration indicates: A) the csi-ReportingBand as a contiguous or non-contiguous subset of subbands in the bandwidth part for which CSI shall be reported; B) wideband CQI or subband CQI reporting, as configured by the higher layer parameter cqi-FormatIndicator; and/or wideband PMI or subband PMI reporting as configured by the higher layer parameter pmi-FormatIndicator.

Note that a UE is not expected to be configured with csi-ReportingBand which contains a subband where a CSI-RS resource linked to the CSI Report setting has the frequency density of each CSI-RS port per PRB in the subband less than the configured density of the CSI-RS resource. If a CSI for Interference Measurement (“CSI-IM”) resource is linked to the CSI Report Setting, a UE is not expected to be configured with csi-ReportingBand which contains a subband where not all PRBs in the subband have the CSI-IM Resource Elements (“REs”) present.

When wideband CQI reporting is configured, a wideband CQI is reported for each codeword for the entire CSI reporting band. When subband CQI reporting is configured, one CQI for each codeword is reported for each subband in the CSI reporting band.

When wideband PMI reporting is configured, a wideband PMI is reported for the entire CSI reporting band. When subband PMI reporting is configured, except with 2 antenna ports, a single wideband indication (i₁ in Clause 5.2.2.2) is reported for the entire CSI reporting band and one subband indication (i₂ in clause 5.2.2.2) is reported for each subband in the CSI reporting band. When subband PMIs are configured with 2 antenna ports, a PMI is reported for each subband in the CSI reporting band. A UE is not expected to be configured with pmi-FormatIndicator if codebookType is set to ‘typeII-r16’ or ‘typeII-PortSelection-r16.’

A CSI Reporting Setting is said to have a wideband frequency-granularity if: A) reportQuantity is set to ‘cri-RI-PMI-CQI,’ or ‘cri-RI-LI-PMI-CQI,’ cqi-FormatIndicator is set to ‘widebandCQI’ and pmi-FormatIndicator is set to ‘widebandPMI’; or reportQuantity is set to ‘cri-RI-i1’; or reportQuantity is set to ‘cri-RI-CQI’ or ‘cri-RI-i1-CQI’ and cqi-FormatIndicator is set to ‘widebandCQI’; or reportQuantity is set to ‘cri-RSRP’ or ‘ssb-Index-RSRP’ or ‘cri-SINR,’ or ‘ssb-Index-SINR’otherwise, the CSI Reporting Setting is said to have a subband frequency-granularity.

If the UE is configured with a CSI Reporting Setting for a bandwidth part with fewer than 24 PRBs, the CSI reporting setting is expected to have a wideband frequency-granularity, and, if applicable, the higher layer parameter codebookType is set to ‘typeI-SinglePanel.’

The first subband size is given by N_{PRB}^{SB}−(N_{BWP,i}^{start}mod N_{PRB}^{SB}) and the last subband size given by (N_{BWP,i}^{start}+N_{BWP,i}^{size})mod N_{PRB}^{SB} if (N_{BWP,i}^{start}+N_{BWP,i}^{size})mod N_{PRB}^{SB}≠0 and N_{PRB}^{SB} if (N_{BWP,i}^{start}+N_{BWP,i}^{size})mod N_{PRB}^{SB}=0

If a UE is configured with semi-persistent CSI reporting, the UE shall report CSI when both CSI-IM and NZP CSI-RS resources are configured as periodic or semi-persistent. If a UE is configured with aperiodic CSI reporting, the UE shall report CSI when both CSI-IM and NZP CSI-RS resources are configured as periodic, semi-persistent or aperiodic.

A UE configured with DCI format 0_1 or 0_2 does not expect to be triggered with multiple CSI reports with the same CSI-ReportConfigId.

Regarding resource setting configuration, for aperiodic CSI, each trigger state configured using the higher layer parameter CSI-AperiodicTriggerState is associated with one or multiple CSI-ReportConfig where each CSI-ReportConfig is linked to periodic, or semi-persistent, or aperiodic resource setting(s). When one Resource Setting is configured, the Resource Setting (given by higher layer parameter resourcesForChannelMeasurement) is for channel measurement for L1-RSRP or for channel and interference measurement for L1-SINR computation. When two Resource Settings are configured, the first one Resource Setting (given by higher layer parameter resourcesForChannelMeasurement) is for channel measurement and the second one (given by either higher layer parameter csi-IM-ResourcesForInterference or higher layer parameter nzp-CSI-RS-ResourcesForInterference) is for interference measurement performed on CSI-IM or on NZP CSI-RS. When three Resource Settings are configured, the first Resource Setting (higher layer parameter resourcesForChannelMeasurement) is for channel measurement, the second one (given by higher layer parameter csi-IM-ResourcesForInterference) is for CSI-IM based interference measurement and the third one (given by higher layer parameter nzp-CSI-RS-ResourcesForInterference) is for NZP CSI-RS based interference measurement.

For semi-persistent or periodic CSI, each CSI-ReportConfig is linked to periodic or semi-persistent Resource Setting(s). When one Resource Setting (given by higher layer parameter resourcesForChannelMeasurement) is configured, the Resource Setting is for channel measurement for L1-RSRP or for channel and interference measurement for L1-SINR computation. When two Resource Settings are configured, the first Resource Setting (given by higher layer parameter resourcesForChannelMeasurement) is for channel measurement and the second Resource Setting (given by higher layer parameter csi-IM-ResourcesForInterference) is used for interference measurement performed on CSI-IM. For L1-SINR computation, the second Resource Setting (given by higher layer parameter csi-IM-ResourcesForInterference or higher layer parameter nzp-CSI-RS-ResourceForInterference) is used for interference measurement performed on CSI-IM or on NZP CSI-RS.

A UE is not expected to be configured with more than one CSI-RS resource in resource set for channel measurement for a CSI-ReportConfig with the higher layer parameter codebookType set to either ‘typeII,’ ‘typeII-PortSelection,’ ‘typeII-r16’ or to ‘typeII-PortSelection-r16.’ A UE is not expected to be configured with more than 64 NZP CSI-RS resources and/or SS/PBCH block resources in resource setting for channel measurement for a CSI-ReportConfig with the higher layer parameter reportQuantity set to ‘none,’ ‘cri-RI-CQI,’ ‘cri-RSRP,’ ‘ssb-Index-RSRP,’ ‘cri-SINR’ or ‘ssb-Index-SINR.’ If interference measurement is performed on CSI-IM, each CSI-RS resource for channel measurement is resource-wise associated with a CSI-IM resource by the ordering of the CSI-RS resource and CSI-IM resource in the corresponding resource sets. The number of CSI-RS resources for channel measurement equals to the number of CSI-IM resources.

Except for L1-SINR, if interference measurement is performed on NZP CSI-RS, a UE does not expect to be configured with more than one NZP CSI-RS resource in the associated resource set within the resource setting for channel measurement. Except for L1-SINR, the UE configured with the higher layer parameter nzp-CSI-RS-ResourcesForinterference may expect no more than 18 NZP CSI-RS ports configured in a NZP CSI-RS resource set.

For CSI measurement(s) other than L1-SINR, a UE assumes: A) each NZP CSI-RS port configured for interference measurement corresponds to an interference transmission layer; B) all interference transmission layers on NZP CSI-RS ports for interference measurement take into account the associated Energy Per Resource Element (“EPRE”) ratios configured in clause 5.2.2.3.1 of 3GPP TS 38.214; C) other interference signal on REs of NZP CSI-RS resource for channel measurement, NZP CSI-RS resource for interference measurement, or CSI-IM resource for interference measurement.

For L1-SINR measurement with dedicated interference measurement resources, a UE assumes: A) the total received power on dedicated NZP CSI-RS resource for interference measurement and/or dedicated CSI-IM resource for interference measurement corresponds to interference and noise.

Regarding report Quantity Configurations, a UE may be configured with a CSI-ReportConfig with the higher layer parameter reportQuantity set to either ‘none,’ ‘cri-RI-PMI-CQI,’ ‘cri-RI-i1,’ ‘cri-RI-i1-CQI,’ ‘cri-RI-CQI,’ ‘cri-RSRP,’ ‘cri-SINR,’ ‘ssb-Index-RS RP,’ ‘ssb-Index-SINR’ or ‘cri-RI-LI-PMI-CQI.’ If the UE is configured with a CSI-ReportConfig with the higher layer parameter reportQuantity set to ‘none,’ then the UE shall not report any quantity for the CSI-ReportConfig.

If the UE is configured with a CSI-ReportConfig with the higher layer parameter reportQuantity set to ‘cri-RI-PMI-CQI,’ or ‘cri-RI-LI-PMI-CQI,’ the UE shall report a preferred precoder matrix for the entire reporting band, or a preferred precoder matrix per subband, according to Clause 5.2.2.2 in 3GPP TS 38.214. If the UE is configured with a CSI-ReportConfig with the higher layer parameter reportQuantity set to ‘cri-RI-i1,’ then the UE expects, for that CSI-ReportConfig, to be configured with higher layer parameter codebookType set to ‘typeI-SinglePanel’ and pmi-FormatIndicator set to ‘widebandPMI’ and, the UE shall report a PMI consisting of a single wideband indication (i₁ in Clause 5.2.2.2.1 in 3GPP TS 38.214) for the entire CSI reporting band.

If the UE is configured with a CSI-ReportConfig with the higher layer parameter reportQuantity set to ‘cri-RI-i1-CQI,’ then the UE expects, for that CSI-ReportConfig, to be configured with higher layer parameter codebookType set to ‘typeI-SinglePanel’ and pmi-FormatIndicator set to ‘widebandPMI’ and, the UE shall report a PMI consisting of a single wideband indication (i₁ in Clause 5.2.2.2.1 in 3GPP TS 38.214) for the entire CSI reporting band. The CQI is calculated conditioned on the reported i₁ assuming PDSCH transmission with Nₚ≥1 precoders (corresponding to the same i₁ but different i₂ in Clause 5.2.2.2.1 in 3GPP TS 38.214), where the UE assumes that one precoder is randomly selected from the set of Nₚ precoders for each Precoding Resource block Group (“PRG”) on PDSCH, where the PRG size for CQI calculation is configured by the higher layer parameter pdsch-BundleSizeForCSI.

If the UE is configured with a CSI-ReportConfig with the higher layer parameter reportQuantity set to ‘cri-RI-CQI,’ then if the UE is configured with higher layer parameter non-PMI-PortIndication contained in a CSI-ReportConfig, r ports are indicated in the order of layer ordering for rank r and each CSI-RS resource in the CSI resource setting is linked to the CSI-ReportConfig based on the order of the associated NZP-CSI-RS-Resourceld in the linked CSI resource setting for channel measurement given by higher layer parameter resourcesForChannelMeasurement. The configured higher layer parameter non-PMI-PortIndication contains a sequence p₀⁽¹⁾, p₀⁽²⁾, p₁⁽²⁾, p₀⁽³⁾, p₁⁽³⁾, p₂⁽³⁾, . . . , p₀^{(R)}, p₁^{(R)}, . . . , p_{R-1}^{(R)} of port indices, where p₀^{(ν)}, . . . , p_{ν-1}^{(ν)} are the CSI-RS port indices associated with rank ν and R∈{1, 2, . . . , P} where P∈{1,2,4,8} is the number of ports in the CSI-RS resource. The UE shall only report RI corresponding to the configured fields of PortIndexFor8Ranks.

Otherwise, if the UE is not configured with higher layer parameter non-PMI-PortIndication, then the UE assumes, for each CSI-RS resource in the CSI resource setting linked to the CSI-ReportConfig, that the CSI-RS port indices p₀^{(ν)}, . . . , p_{ν-1}^{(ν)}={0, . . . , ν−1} are associated with ranks ν=1, 2, . . . , P where P∈{1,2,4,8} is the number of ports in the CSI-RS resource. When calculating the CQI for a rank, the UE shall use the ports indicated for that rank for the selected CSI-RS resource. The precoder for the indicated ports shall be assumed to be the identity matrix scaled by

$$\\ \frac{1}{\sqrt{v}} .$$

If the UE is configured with a CSI-ReportConfig with the higher layer parameter reportQuantity set to ‘cri-RSRP’ or ‘ssb-Index-RSRP,’ then if the UE is configured with the higher layer parameter groupBasedBeamReporting set to ‘disabled,’ the UE is not required to update measurements for more than 64 CSI-RS and/or SSB resources, and the UE shall report in a single report nrofReportedRS (higher layer configured) different CRI or SSBRI for each report setting. Otherwise, if the UE is configured with the higher layer parameter groupBasedBeamReporting set to ‘enabled,’ the UE is not required to update measurements for more than 64 CSI-RS and/or SSB resources, and the UE shall report in a single reporting instance two different CRI or SSBRI for each report setting, where CSI-RS and/or SSB resources can be received simultaneously by the UE either with a single spatial domain receive filter, or with multiple simultaneous spatial domain receive filters.

If the UE is configured with a CSI-ReportConfig with the higher layer parameter reportQuantity set to ‘cri-SINR’ or ‘ssb-Index-SINR,’ then if the UE is configured with the higher layer parameter groupBasedBeamReporting set to ‘disabled,’ the UE shall report in a single report nrofReportedRS (higher layer configured) different CRI or SSBRI for each report setting. Otherwise, if the UE is configured with the higher layer parameter groupBasedBeamReporting set to ‘enabled,’ the UE shall report in a single reporting instance two different CRI or SSBRI for each report setting, where CSI-RS and/or SSB resources can be received simultaneously by the UE.

If the UE is configured with a CSI-ReportConfig with the higher layer parameter reportQuantity set to ‘cri-RSRP,’ ‘cri-RI-PMI-CQI,’ ‘cri-RI-i1,’ ‘cri-RI-i1-CQI,’ ‘cri-RI-CQI,’ ‘cri-RI-LI-PMI-CQI,’ or ‘cri-SINR,’ and Kₛ>1 resources are configured in the corresponding resource set for channel measurement, then the UE shall derive the CSI parameters other than CRI conditioned on the reported CRI, where CRI k (k≥0) corresponds to the configured (k+1)-th entry of associated nzp-CSI-RS-Re sources in the corresponding NZP-CSI-RS-ResourceSet for channel measurement, and (k+1)-th entry of associated csi-IM-Resource in the corresponding csi-IM-ResourceSet (if configured) or (k+1)-th entry of associated nzp-CSI-RS-Resources in the corresponding NZP-CSI-RS-ResourceSet (if configured for CSI-ReportConfig with reportQuantity set to ‘cri-SINR’) for interference measurement. If Kₛ=2 CSI-RS resources are configured, each resource shall contain at most 16 CSI-RS ports. If 2<Kₛ≤8 CSI-RS resources are configured, each resource shall contain at most 8 CSI-RS ports.

If the UE is configured with a CSI-ReportConfig with the higher layer parameter reportQuantity set to ‘ssb-Index-RSRP,’ the UE shall report SSBRI, where SSBRI k (k≥0) corresponds to the configured (k+1)-th entry of the associated csi-SSB-ResourceList in the corresponding CSI-SSB-ResourceSet.

If the UE is configured with a CSI-ReportConfig with the higher layer parameter reportQuantity set to ‘ssb-Index-SINR,’ the UE shall derive L1-SINR conditioned on the reported SSBRI, where SSBRI k (k≥0) corresponds to the configured (k+1)-th entry of the associated csi-SSB-ResourceList in the corresponding CSI-SSB-ResourceSet for channel measurement, and (k+1)-th entry of associated csi-IM-Resource in the corresponding csi-IM-ResourceSet (if configured) or (k+1)-th entry of associated nzp-CSI-RS-Resources in the corresponding NZP-CSI-RS-ResourceSet (if configured) for interference measurement.

If the UE is configured with a CSI-ReportConfig with the higher layer parameter reportQuantity set to ‘cri-RI-PMI-CQI,’ ‘cri-RI-i1,’ ‘cri-RI-i1-CQI,’ ‘cri-RI-CQI’ or ‘cri-RI-LI-PMI-CQI,’ then the UE is not expected to be configured with more than 8 CSI-RS resources in a CSI-RS resource set contained within a resource setting that is linked to the CSI-ReportConfig.

If the UE is configured with a CSI-ReportConfig with higher layer parameter reportQuantity set to ‘cri-RSRP,’ ‘cri-SINR’ or ‘none’ and the CSI-ReportConfig is linked to a resource setting configured with the higher layer parameter resourceType set to ‘aperiodic,’ then the UE is not expected to be configured with more than 16 CSI-RS resources in a CSI-RS resource set contained within the resource setting.

The LI indicates which column of the precoder matrix of the reported PMI corresponds to the strongest layer of the codeword corresponding to the largest reported wideband CQI. If two wideband CQIs are reported and have equal value, the LI corresponds to strongest layer of the first codeword.

For operation with shared spectrum channel access, if the UE is configured with a CSI-ReportConfig with higher layer parameter reportQuantity set to ‘cri-RI-PMI-CQI,’ ‘cri-RI-i1,’ ‘cri-RI-i1-CQI,’ ‘cri-RI-CQI’ or ‘cri-RI-LI-PMI-CQI,’ the UE shall derive at least one of the following information: A) the CSI parameters without averaging two or more instances of any periodic or semi-persistent nzp-CSI-RS-Resources in the corresponding NZP-CSI-RS-ResourceSet for channel measurement or for interference measurement located in different DL transmissions; B) the instances of the nzp-CSI-RS-Resources are not in the same channel occupancy duration indicated by DCI format 2_0, if the UE is provided at least one of SlotFormatIndicator or co-DurationList; C) the instances of the nzp-CSI-RS-Resources occur in a set of symbols which are not all occupied by PDSCH(s) and/or aperiodic CSI-RS(s) indicated by DCI formats and the corresponding PDDCH(s), if the UE is neither provided with CO-DurationPerCell nor SlotFormatIndicator, but is provided with csi-RS-ValidationWith-DCI; and/or D) the interference measurements for computing CSI value based on periodic/semi-persistent CSI-IM measured only in Orthogonal Frequency Division Multiplexing (“OFDM”) symbol(s) that fulfill the same conditions under which the UE is expected to receive periodic/semi-persistent CSI-RS, e.g., as described in Clause 11.1 and Clause 11.1.1 of 3GPP TS 38.213.

Regarding L1-RSRP reporting, for L1-RSRP computation the UE may be configured with CSI-RS resources, SS/PBCH Block resources or both CSI-RS and SS/PBCH block resources, when resource-wise quasi co-located with ‘type C’ and ‘typeD’ when applicable. In some embodiments, the UE may be configured with CSI-RS resource setting up to 16 CSI-RS resource sets having up to 64 resources within each set. The total number of different CSI-RS resources over all resource sets is no more than 128.

For L1-RSRP reporting, if the higher layer parameter nrofReportedRS in CSI-ReportConfig is configured to be one, the reported L1-RSRP value is defined by a 7-bit value in the range [−140, −44] dBm with 1 dB step size, if the higher layer parameter nrofReportedRS is configured to be larger than one, or if the higher layer parameter groupBasedBeamReporting is configured as ‘enabled,’ the UE shall use differential L1-RSRP based reporting, where the largest measured value of L1-RSRP is quantized to a 7-bit value in the range [−140, −44] dBm with 1 dB step size, and the differential L1-RSRP is quantized to a 4-bit value. The differential L1-RSRP value is computed with 2 dB step size with a reference to the largest measured L1-RSRP value which is part of the same L1-RSRP reporting instance. The mapping between the reported L1-RSRP value and the measured quantity is described in 3GPP TS 38.133.

If a UE is not configured with higher layer parameter timeRestrictionForChannelMeasurements in CSI-ReportConfig, the UE shall derive the channel measurements for computing L1-RSRP value reported in uplink slot n based on only the SS/PBCH or NZP CSI-RS, no later than the CSI reference resource, (defined in 3GPP TS 38.211) associated with the CSI resource setting.

If a UE is configured with higher layer parameter timeRestrictionForChannelMeasurements in CSI-ReportConfig, the UE shall derive the channel measurements for computing L1-RSRP reported in uplink slot n based on only the most recent, no later than the CSI reference resource, occasion of SS/PBCH or NZP CSI-RS (defined in 3GPP TS 38.211) associated with the CSI resource setting.

Regarding L1-SINR reporting, for L1-SINR computation, for channel measurement the UE may be configured with NZP CSI-RS resources and/or SS/PBCH Block resources, for interference measurement the UE may be configured with NZP CSI-RS or CSI-IM resources. For channel measurement, the UE may be configured with CSI-RS resource setting with up to 16 resource sets, with a total of up to 64 CSI-RS resources or up to 64 SS/PBCH Block resources.

For L1-SINR reporting, if the higher layer parameter nrofReportedRS in CSI-ReportConfig is configured to be one, the reported L1-SINR value is defined by a 7-bit value in the range [−23, 40] dB with 0.5 dB step size, and if the higher layer parameter nrofReportedRS is configured to be larger than one, or if the higher layer parameter groupBasedBeamReporting is configured as ‘enabled,’ the UE shall use differential L1-SINR based reporting, where the largest measured value of L1-SINR is quantized to a 7-bit value in the range [−23, 40] dB with 0.5 dB step size, and the differential L1-SINR is quantized to a 4-bit value. The differential L1-SINR is computed with 1 dB step size with a reference to the largest measured L1-SINR value which is part of the same L1-SINR reporting instance. When NZP CSI-RS is configured for channel measurement and/or interference measurement, the reported L1-SINR values should not be compensated by the power offset(s) given by higher layer parameter powerControOffsetSS or powerControlOffset.

If a UE is not configured with higher layer parameter timeRestrictionForChannelMeasurements in CSI-ReportConfig, then the UE shall derive the channel measurements for computing L1-SINR reported in uplink slot n based on only the SSB or NZP CSI-RS, no later than the CSI reference resource, (defined in 3GPP TS 38.211) associated with the CSI resource setting. However, if the UE is configured with higher layer parameter timeRestrictionForChannelMeasurements in CSI-ReportConfig, the UE shall derive the channel measurements for computing L1-SINR reported in uplink slot n based on only the most recent, no later than the CSI reference resource, occasion of SSB or NZP CSI-RS (defined in 3GPP TS 38.211) associated with the CSI resource setting.

If a UE is not configured with higher layer parameter timeRestrictionForInterferenceMeasurements in CSI-ReportConfig, the UE shall derive the interference measurements for computing L1-SINR reported in uplink slot n based on only the CSI-IM or NZP CSI-RS for interference measurement (defined in 3GPP TS 38.211) or NZP CSI-RS for channel and interference measurement no later than the CSI reference resource associated with the CSI resource setting. However, if the UE is configured with higher layer parameter timeRestrictionForInterferenceMeasurements in CSI-ReportConfig, the UE shall derive the interference measurements for computing the L1-SINR reported in uplink slot n based on the most recent, no later than the CSI reference resource, occasion of CSI-IM or NZP CSI-RS for interference measurement (defined in 3GPP TS 38.211) or NZP CSI-RS for channel and interference measurement associated with the CSI resource setting.

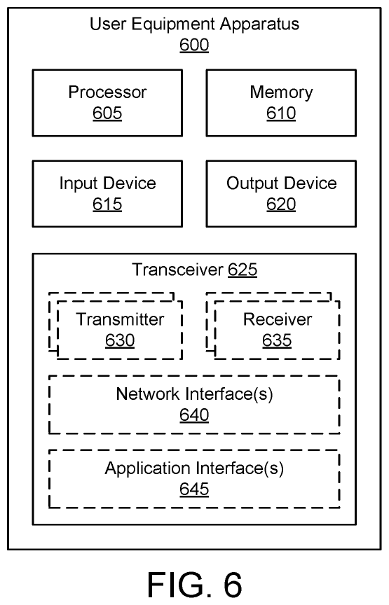

FIG. 6 depicts a user equipment apparatus 600 that may be used for CSI reporting prediction, according to embodiments of the disclosure. In various embodiments, the user equipment apparatus 600 is used to implement one or more of the solutions described above. The user equipment apparatus 600 may be one embodiment of the remote unit 105, the UE 205, and/or the user equipment apparatus 600, described above. Furthermore, the user equipment apparatus 600 may include a processor 605, a memory 610, an input device 615, an output device 620, and a transceiver 625.

In some embodiments, the input device 615 and the output device 620 are combined into a single device, such as a touchscreen. In certain embodiments, the user equipment apparatus 600 may not include any input device 615 and/or output device 620. In various embodiments, the user equipment apparatus 600 may include one or more of: the processor 605, the memory 610, and the transceiver 625, and may not include the input device 615 and/or the output device 620.

As depicted, the transceiver 625 includes at least one transmitter 630 and at least one receiver 635. In some embodiments, the transceiver 625 communicates with one or more cells (or wireless coverage areas) supported by one or more base units 121. In various embodiments, the transceiver 625 is operable on unlicensed spectrum. Moreover, the transceiver 625 may include multiple UE panels supporting one or more beams. Additionally, the transceiver 625 may support at least one network interface 640 and/or application interface 645. The application interface(s) 645 may support one or more APIs. The network interface(s) 640 may support 3GPP reference points, such as Uu, N1, PC5, etc. Other network interfaces 640 may be supported, as understood by one of ordinary skill in the art.

The processor 605, in one embodiment, may include any known controller capable of executing computer-readable instructions and/or capable of performing logical operations. For example, the processor 605 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 605 executes instructions stored in the memory 610 to perform the methods and routines described herein. The processor 605 is communicatively coupled to the memory 610, the input device 615, the output device 620, and the transceiver 625.

In various embodiments, the processor 605 controls the user equipment apparatus 600 to implement the above described UE behaviors. In certain embodiments, the processor 605 may include an application processor (also known as “main processor”) which manages application-domain and operating system (“OS”) functions and a baseband processor (also known as “baseband radio processor”) which manages radio functions.

In various embodiments, via the transceiver 625, the processor 605 receives a configuration from a RAN to report a sequence of beams that are applicable for, e.g., beam-based wireless communication. The processor 605 performs beam quality measurements on resources configured by the RAN (i.e., by receiving and determines a sequence of beams based on the measurements, where the sequence of beams comprises a series of best beams for a period of time. The processor 605 controls the transceiver 625 to report the sequence of beams to the RAN.

In various embodiments, the beam-based wireless communication comprises downlink reception, uplink transmission, or a combination thereof. In some embodiments, reporting the sequence of beams includes reporting a duration for which each of the beams in the reported sequence are applicable to be used for wireless communication.

In certain embodiments, reporting a duration for which each of the beams in the reported sequence are applicable to be used for wireless communication comprises reporting a single duration that is applicable for each of the beams within the reported sequence. In certain embodiments, reporting a duration for which each of the beams in the reported sequence are applicable to be used for wireless communication comprises reporting a separate duration for each of the beams within the reported sequence.

In certain embodiments, reporting a duration for which each of the beams in the reported sequence are applicable to be used for wireless communication comprises reporting a total duration within which the entire sequence of reported beams is applicable. In such embodiments, a separate duration for each of the beams is determinable based on a total number of beams in the sequence of beams and the total duration.

In certain embodiments, reporting the sequence of beams includes indicating each of the reported beams within the sequence by a resource index value. In one embodiment, the resource index value includes a CRI. In another embodiment, the resource index value includes a SSBRI.

In some embodiments, the reported sequence of beams corresponds to a sequence of TRPs, wherein each beam within the sequence of beams is associated with a different TRP. In some embodiments, reporting the sequence of beams to the RAN comprises reporting at least one beam quality for each beam within the sequence of beam, the at least one beam quality comprising one or more of: CQI, RI, LI, PMI, L1-RSRP, L1-SINR, or some combination thereof.

In some embodiments, receiving the configuration from the RAN includes receiving a configuration with one or more CSI reporting settings with one or more CSI resources settings. In such embodiments, performing the beam quality measurements includes performing CSI measurements on multiple configured CSI resources. In certain embodiments, each CSI reporting setting is associated with one or more of: a channel measurement resource setting, an interference measurements resource setting, or some combination thereof.

In certain embodiments, the UE is configured with a single CSI reporting setting with a single CSI resource setting, wherein a QCL Type-D assumption of the configured CSI resources to perform CSI measurements is time varying. In certain embodiments, the UE is configured with a single CSI reporting setting with multiple CSI resource settings, wherein one of the beams within the sequence is associated with a CSI resource setting of the multiple CSI resource settings. In certain embodiments, the UE is configured with multiple CSI reporting settings, each report setting associated with multiple CSI resource settings, wherein each of the CSI reporting setting corresponds to one of the reported beams within the sequence.

The memory 610, in one embodiment, is a computer readable storage medium. In some embodiments, the memory 610 includes volatile computer storage media. For example, the memory 610 may include a RAM, including dynamic RAM (“DRAM”), synchronous dynamic RAM (“SDRAM”), and/or static RAM (“SRAM”). In some embodiments, the memory 610 includes non-volatile computer storage media. For example, the memory 610 may include a hard disk drive, a flash memory, or any other suitable non-volatile computer storage device. In some embodiments, the memory 610 includes both volatile and non-volatile computer storage media.

In some embodiments, the memory 610 stores data related to associating transmit beams and sensing beams for channel access and/or mobile operation. For example, the memory 610 may store various parameters, panel/beam configurations, resource assignments, policies, and the like as described above. In certain embodiments, the memory 610 also stores program code and related data, such as an operating system or other controller algorithms operating on the apparatus 600.

The input device 615, in one embodiment, may include any known computer input device including a touch panel, a button, a keyboard, a stylus, a microphone, or the like. In some embodiments, the input device 615 may be integrated with the output device 620, for example, as a touchscreen or similar touch-sensitive display. In some embodiments, the input device 615 includes a touchscreen such that text may be input using a virtual keyboard displayed on the touchscreen and/or by handwriting on the touchscreen. In some embodiments, the input device 615 includes two or more different devices, such as a keyboard and a touch panel.

The output device 620, in one embodiment, is designed to output visual, audible, and/or haptic signals. In some embodiments, the output device 620 includes an electronically controllable display or display device capable of outputting visual data to a user. For example, the output device 620 may include, but is not limited to, a Liquid Crystal Display (“LCD”), a Light-Emitting Diode (“LED”) display, an Organic LED (“OLED”) display, a projector, or similar display device capable of outputting images, text, or the like to a user. As another, non-limiting, example, the output device 620 may include a wearable display separate from, but communicatively coupled to, the rest of the user equipment apparatus 600, such as a smart watch, smart glasses, a heads-up display, or the like. Further, the output device 620 may be a component of a smart phone, a personal digital assistant, a television, a table computer, a notebook (laptop) computer, a personal computer, a vehicle dashboard, or the like.

In certain embodiments, the output device 620 includes one or more speakers for producing sound. For example, the output device 620 may produce an audible alert or notification (e.g., a beep or chime). In some embodiments, the output device 620 includes one or more haptic devices for producing vibrations, motion, or other haptic feedback. In some embodiments, all or portions of the output device 620 may be integrated with the input device 615. For example, the input device 615 and output device 620 may form a touchscreen or similar touch-sensitive display. In other embodiments, the output device 620 may be located near the input device 615.

The transceiver 625 communicates with one or more network functions of a mobile communication network via one or more access networks. The transceiver 625 operates under the control of the processor 605 to transmit messages, data, and other signals and also to receive messages, data, and other signals. For example, the processor 605 may selectively activate the transceiver 625 (or portions thereof) at particular times in order to send and receive messages.

The transceiver 625 includes at least transmitter 630 and at least one receiver 635. One or more transmitters 630 may be used to provide UL communication signals to a base unit 121, such as the UL transmissions described herein. Similarly, one or more receivers 635 may be used to receive DL communication signals from the base unit 121, as described herein. Although only one transmitter 630 and one receiver 635 are illustrated, the user equipment apparatus 600 may have any suitable number of transmitters 630 and receivers 635. Further, the transmitter(s) 630 and the receiver(s) 635 may be any suitable type of transmitters and receivers. In one embodiment, the transceiver 625 includes a first transmitter/receiver pair used to communicate with a mobile communication network over licensed radio spectrum and a second transmitter/receiver pair used to communicate with a mobile communication network over unlicensed radio spectrum.

In certain embodiments, the first transmitter/receiver pair used to communicate with a mobile communication network over licensed radio spectrum and the second transmitter/receiver pair used to communicate with a mobile communication network over unlicensed radio spectrum may be combined into a single transceiver unit, for example a single chip performing functions for use with both licensed and unlicensed radio spectrum. In some embodiments, the first transmitter/receiver pair and the second transmitter/receiver pair may share one or more hardware components. For example, certain transceivers 625, transmitters 630, and receivers 635 may be implemented as physically separate components that access a shared hardware resource and/or software resource, such as for example, the network interface 640.

In various embodiments, one or more transmitters 630 and/or one or more receivers 635 may be implemented and/or integrated into a single hardware component, such as a multi-transceiver chip, a system-on-a-chip, an Application-Specific Integrated Circuit (“ASIC”), or other type of hardware component. In certain embodiments, one or more transmitters 630 and/or one or more receivers 635 may be implemented and/or integrated into a multi-chip module. In some embodiments, other components such as the network interface 640 or other hardware components/circuits may be integrated with any number of transmitters 630 and/or receivers 635 into a single chip. In such embodiment, the transmitters 630 and receivers 635 may be logically configured as a transceiver 625 that uses one more common control signals or as modular transmitters 630 and receivers 635 implemented in the same hardware chip or in a multi-chip module.

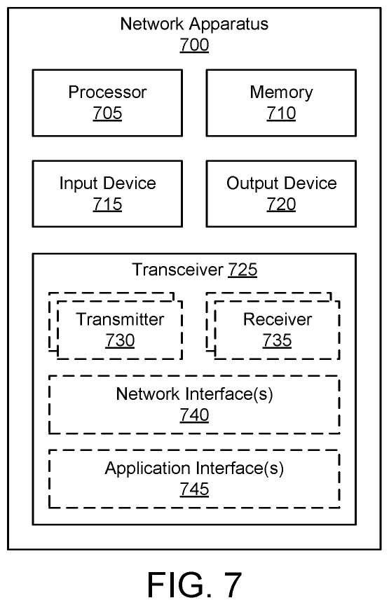

FIG. 7 depicts a network apparatus 700 that may be used for CSI reporting prediction, according to embodiments of the disclosure. In one embodiment, network apparatus 700 may be one implementation of a RAN device, such as the base unit 121, as described above. Furthermore, the network apparatus 700 may include a processor 705, a memory 710, an input device 715, an output device 720, and a transceiver 725.

In some embodiments, the input device 715 and the output device 720 are combined into a single device, such as a touchscreen. In certain embodiments, the network apparatus 700 may not include any input device 715 and/or output device 720. In various embodiments, the network apparatus 700 may include one or more of: the processor 705, the memory 710, and the transceiver 725, and may not include the input device 715 and/or the output device 720.

As depicted, the transceiver 725 includes at least one transmitter 730 and at least one receiver 735. Here, the transceiver 725 communicates with one or more remote units 105. Additionally, the transceiver 725 may support at least one network interface 740 and/or application interface 745. The application interface(s) 745 may support one or more APIs. The network interface(s) 740 may support 3GPP reference points, such as Uu, N1, N2 and N3. Other network interfaces 740 may be supported, as understood by one of ordinary skill in the art.

The processor 705, in one embodiment, may include any known controller capable of executing computer-readable instructions and/or capable of performing logical operations. For example, the processor 705 may be a microcontroller, a microprocessor, a CPU, a GPU, an auxiliary processing unit, a FPGA, or similar programmable controller. In some embodiments, the processor 705 executes instructions stored in the memory 710 to perform the methods and routines described herein. The processor 705 is communicatively coupled to the memory 710, the input device 715, the output device 720, and the transceiver 725.

In various embodiments, the network apparatus 700 is a RAN node (e.g., gNB) that communicates with one or more UEs, as described herein. In such embodiments, the processor 705 controls the network apparatus 700 to perform the above described RAN behaviors. When operating as a RAN node, the processor 705 may include an application processor (also known as “main processor”) which manages application-domain and operating system (“OS”) functions and a baseband processor (also known as “baseband radio processor”) which manages radio functions.

In various embodiments, the processor 705 configures a UE, via the transceiver 725, with a first configuration for reporting a sequence of beams that are applicable for, e.g., beam-based wireless communication. The transceiver 725 transmits one or more reference signals using one or more resources configured by RAN and receives a sequence of beams from the UE, where the sequence of beams contains a series of best beams for a period of time.

In some embodiments, the processor 705 performs beam-based wireless communication with the UE based on the received sequence of beams. In various embodiments, the beam-based wireless communication includes downlink transmission, uplink reception, or a combination thereof. In some embodiments, receiving the sequence of beams includes receiving a duration for which each of the beams in the reported sequence are applicable to be used for wireless communication.

In certain embodiments, receiving the duration for which each of the beams in the reported sequence are applicable to be used for wireless communication includes receiving a single duration that is applicable for each of the beams within the reported sequence. In certain embodiments, receiving the duration for which each of the beams in the reported sequence are applicable to be used for wireless communication includes receiving a separate duration for each of the beams within the reported sequence.

In certain embodiments, receiving the duration for which each of the beams in the reported sequence are applicable to be used for wireless communication includes receiving a total duration within which the entire sequence of reported beams is applicable. In such embodiments, the processor further determines a separate duration for each of the beams based on a total number of beams in the sequence of beams and the total duration.

In some embodiments, receiving the sequence of beams includes receiving a set of resource index values indicating each of the reported beams within the sequence. In one embodiment, the resource index value includes a CRI. In another embodiment, the resource index value includes a SSBRI.

In some embodiments, the reported sequence of beams corresponds to a sequence of TRPs and each beam within the sequence of beams is associated with a different TRP. In some embodiments, receiving the sequence of beams from the UE includes receiving at least one beam quality for each beam within the sequence of beam, the at least one beam quality containing one or more of: CQI, RI, LI, PMI, L1-RSRP, L1-SINR, or some combination thereof.

In some embodiments, transmitting the configuration to the UE includes configuring the UE with one or more CSI reporting settings with one or more CSI resources settings. In certain embodiments, each CSI reporting setting is associated with one or more of: a channel measurement resource setting, an interference measurements resource setting, or some combination thereof.

In certain embodiments, the UE is configured with a single CSI reporting setting with a single CSI resource setting, where a QCL Type-D assumption of the configured CSI resources to perform CSI measurements is time varying. In certain embodiments, the UE is configured with a single CSI reporting setting with multiple CSI resource settings, where one of the beams within the sequence is associated with a CSI resource setting of the multiple CSI resource settings. In certain embodiments, the UE is configured with multiple CSI reporting settings, each report setting associated with multiple CSI resource settings, where each of the CSI reporting setting corresponds to one of the reported beams within the sequence.

The memory 710, in one embodiment, is a computer readable storage medium. In some embodiments, the memory 710 includes volatile computer storage media. For example, the memory 710 may include a RAM, including dynamic RAM (“DRAM”), synchronous dynamic RAM (“SDRAM”), and/or static RAM (“SRAM”). In some embodiments, the memory 710 includes non-volatile computer storage media. For example, the memory 710 may include a hard disk drive, a flash memory, or any other suitable non-volatile computer storage device. In some embodiments, the memory 710 includes both volatile and non-volatile computer storage media.

In some embodiments, the memory 710 stores data related to associating transmit beams and sensing beams for channel access and/or mobile operation. For example, the memory 710 may store parameters, configurations, resource assignments, policies, and the like, as described above. In certain embodiments, the memory 710 also stores program code and related data, such as an operating system or other controller algorithms operating on the apparatus 700.

The input device 715, in one embodiment, may include any known computer input device including a touch panel, a button, a keyboard, a stylus, a microphone, or the like. In some embodiments, the input device 715 may be integrated with the output device 720, for example, as a touchscreen or similar touch-sensitive display. In some embodiments, the input device 715 includes a touchscreen such that text may be input using a virtual keyboard displayed on the touchscreen and/or by handwriting on the touchscreen. In some embodiments, the input device 715 includes two or more different devices, such as a keyboard and a touch panel.

The output device 720, in one embodiment, is designed to output visual, audible, and/or haptic signals. In some embodiments, the output device 720 includes an electronically controllable display or display device capable of outputting visual data to a user. For example, the output device 720 may include, but is not limited to, an LCD display, an LED display, an OLED display, a projector, or similar display device capable of outputting images, text, or the like to a user. As another, non-limiting, example, the output device 720 may include a wearable display separate from, but communicatively coupled to, the rest of the network apparatus 700, such as a smart watch, smart glasses, a heads-up display, or the like. Further, the output device 720 may be a component of a smart phone, a personal digital assistant, a television, a table computer, a notebook (laptop) computer, a personal computer, a vehicle dashboard, or the like.

In certain embodiments, the output device 720 includes one or more speakers for producing sound. For example, the output device 720 may produce an audible alert or notification (e.g., a beep or chime). In some embodiments, the output device 720 includes one or more haptic devices for producing vibrations, motion, or other haptic feedback. In some embodiments, all or portions of the output device 720 may be integrated with the input device 715. For example, the input device 715 and output device 720 may form a touchscreen or similar touch-sensitive display. In other embodiments, the output device 720 may be located near the input device 715.

The transceiver 725 includes at least transmitter 730 and at least one receiver 735. One or more transmitters 730 may be used to communicate with the UE, as described herein. Similarly, one or more receivers 735 may be used to communicate with network functions in the Public Land Mobile Network (“PLMN”) and/or RAN, as described herein. Although only one transmitter 730 and one receiver 735 are illustrated, the network apparatus 700 may have any suitable number of transmitters 730 and receivers 735. Further, the transmitter(s) 730 and the receiver(s) 735 may be any suitable type of transmitters and receivers.

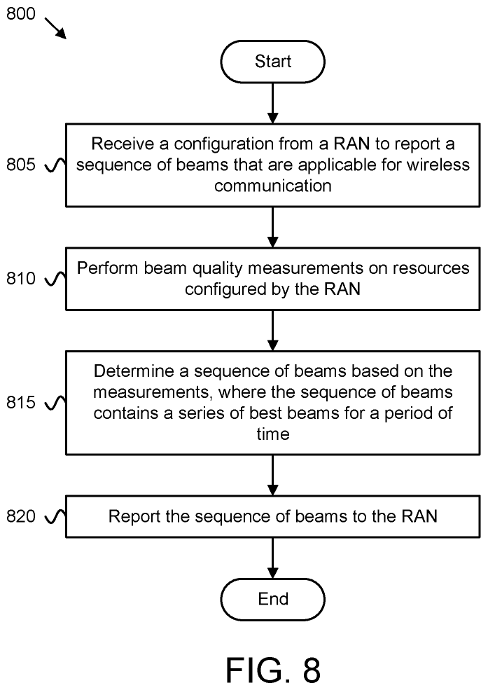

FIG. 8 depicts one embodiment of a method 800 for CSI reporting prediction, according to embodiments of the disclosure. In various embodiments, the method 800 is performed by a UE device, such as the remote unit 105, the UE 205, and/or the user equipment apparatus 600, described above as described above. In some embodiments, the method 800 is performed by a processor, such as a microcontroller, a microprocessor, a CPU, a GPU, an auxiliary processing unit, a FPGA, or the like.

The method 800 begins and receives 805 a configuration from a RAN to report a sequence of beams that are applicable for wireless communication (i.e., DL reception, UL transmission, or a combination thereof). The method 800 includes performing 810 beam quality measurements on resources configured by the RAN. The method 800 includes determining 815 a sequence of beams based on the measurements, where the sequence of beams contains a series of best beams for a period of time. The method 800 includes reporting 820 the sequence of beams to the RAN. The method 800 ends.

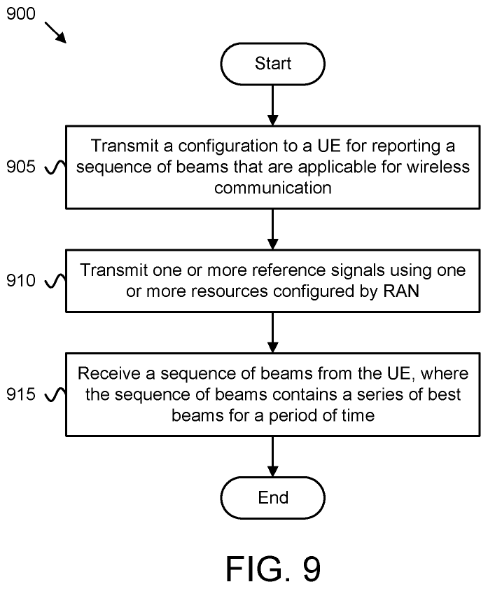

FIG. 9 depicts one embodiment of a method 900 for CSI reporting prediction, according to embodiments of the disclosure. In various embodiments, the method 900 is performed by a network entity, such as the base unit 121, the RAN node 210, and/or the network apparatus 700, described above as described above. In some embodiments, the method 900 is performed by a processor, such as a microcontroller, a microprocessor, a CPU, a GPU, an auxiliary processing unit, a FPGA, or the like.

The method 900 begins and transmits 905 a configuration to a UE for reporting a sequence of beams that are applicable for wireless communication (i.e., DL transmission, UL reception, or a combination thereof). The method 900 includes transmitting 910 one or more reference signals using one or more resources configured by RAN. The method 900 includes receiving 915 a sequence of beams from the UE, where the sequence of beams contains a series of best beams for a period of time. The method 900 ends.

Disclosed herein is a first apparatus for CSI reporting prediction, according to embodiments of the disclosure. The first apparatus may be implemented by a UE device, such as the remote unit 105, the UE 205, and/or the user equipment apparatus 600, described above. The first apparatus includes a receiver that receives a configuration from a RAN to report a sequence of beams that are applicable for wireless communication. The first apparatus includes a processor that performs beam quality measurements on resources configured by the RAN and determines a sequence of beams based on the measurements, wherein the sequence of beams comprises a series of best beams for a period of time. The first apparatus includes a transmitter that reports the sequence of beams to the RAN.

In various embodiments, the wireless communication comprises downlink reception, uplink transmission, or a combination thereof. In some embodiments, reporting the sequence of beams includes reporting a duration for which each of the beams in the reported sequence are applicable to be used for wireless communication.

In certain embodiments, reporting a duration for which each of the beams in the reported sequence are applicable to be used for wireless communication comprises reporting a single duration that is applicable for each of the beams within the reported sequence. In certain embodiments, reporting a duration for which each of the beams in the reported sequence are applicable to be used for wireless communication comprises reporting a separate duration for each of the beams within the reported sequence.

In certain embodiments, reporting a duration for which each of the beams in the reported sequence are applicable to be used for wireless communication comprises reporting a total duration within which the entire sequence of reported beams is applicable. In such embodiments, a separate duration for each of the beams is determinable based on a total number of beams in the sequence of beams and the total duration.

In certain embodiments, reporting the sequence of beams includes indicating each of the reported beams within the sequence by a resource index value. In one embodiment, the resource index value includes a CRI. In another embodiment, the resource index value includes a SSBRI.

In some embodiments, the reported sequence of beams corresponds to a sequence of TRPs, wherein each beam within the sequence of beams is associated with a different TRP. In some embodiments, reporting the sequence of beams to the RAN comprises reporting at least one beam quality for each beam within the sequence of beam, the at least one beam quality comprising one or more of: CQI, RI, LI, PMI, L1-RSRP, L1-SINR, or some combination thereof.

In some embodiments, receiving the configuration from the RAN includes receiving a configuration with one or more CSI reporting settings with one or more CSI resources settings. In such embodiments, performing the beam quality measurements includes performing CSI measurements on multiple configured CSI resources. In certain embodiments, each CSI reporting setting is associated with one or more of: a channel measurement resource setting, an interference measurements resource setting, or some combination thereof.

In certain embodiments, the UE is configured with a single CSI reporting setting with a single CSI resource setting, wherein a QCL Type-D assumption of the configured CSI resources to perform CSI measurements is time varying. In certain embodiments, the UE is configured with a single CSI reporting setting with multiple CSI resource settings, wherein one of the beams within the sequence is associated with a CSI resource setting of the multiple CSI resource settings. In certain embodiments, the UE is configured with multiple CSI reporting settings, each report setting associated with multiple CSI resource settings, wherein each of the CSI reporting setting corresponds to one of the reported beams within the sequence.

Disclosed herein is a first method for CSI reporting prediction, according to embodiments of the disclosure. The first method may be performed by a UE device, such as the remote unit 105, the UE 205, and/or the user equipment apparatus 600, described above. The first method includes
receiving a configuration from a RAN to report a sequence of beams that are applicable for wireless communication and performing beam quality measurements on resources configured by the RAN. The first method includes determining a sequence of beams based on the measurements and reporting the sequence of beams to the RAN, where the sequence of beams contains a series of best beams for a period of time.

In various embodiments, the wireless communication comprises downlink reception, uplink transmission, or a combination thereof. In some embodiments, reporting the sequence of beams includes reporting a duration for which each of the beams in the reported sequence are applicable to be used for wireless communication.

In certain embodiments, reporting a duration for which each of the beams in the reported sequence are applicable to be used for wireless communication comprises reporting a single duration that is applicable for each of the beams within the reported sequence. In certain embodiments, reporting a duration for which each of the beams in the reported sequence are applicable to be used for wireless communication comprises reporting a separate duration for each of the beams within the reported sequence.

In certain embodiments, reporting a duration for which each of the beams in the reported sequence are applicable to be used for wireless communication comprises reporting a total duration within which the entire sequence of reported beams is applicable. In such embodiments, a separate duration for each of the beams is determinable based on a total number of beams in the sequence of beams and the total duration.

In certain embodiments, reporting the sequence of beams includes indicating each of the reported beams within the sequence by a resource index value. In one embodiment, the resource index value includes a CRI. In another embodiment, the resource index value includes a SSBRI.

In some embodiments, the reported sequence of beams corresponds to a sequence of TRPs, wherein each beam within the sequence of beams is associated with a different TRP. In some embodiments, reporting the sequence of beams to the RAN comprises reporting at least one beam quality for each beam within the sequence of beam, the at least one beam quality comprising one or more of: CQI, RI, LI, PMI, L1-RSRP, L1-SINR, or some combination thereof.

In some embodiments, receiving the configuration from the RAN includes receiving a configuration with one or more CSI reporting settings with one or more CSI resources settings. In such embodiments, performing the beam quality measurements includes performing CSI measurements on multiple configured CSI resources. In certain embodiments, each CSI reporting setting is associated with one or more of: a channel measurement resource setting, an interference measurements resource setting, or some combination thereof.

In certain embodiments, the UE is configured with a single CSI reporting setting with a single CSI resource setting, wherein a QCL Type-D assumption of the configured CSI resources to perform CSI measurements is time varying. In certain embodiments, the UE is configured with a single CSI reporting setting with multiple CSI resource settings, wherein one of the beams within the sequence is associated with a CSI resource setting of the multiple CSI resource settings. In certain embodiments, the UE is configured with multiple CSI reporting settings, each report setting associated with multiple CSI resource settings, wherein each of the CSI reporting setting corresponds to one of the reported beams within the sequence.

Disclosed herein is a second apparatus for CSI reporting prediction, according to embodiments of the disclosure. The second apparatus may be implemented by a network entity, such as the base unit 121, the RAN node 210, and/or the network apparatus 700, described above. The second apparatus includes a processor that configures a UE for reporting a sequence of beams that are applicable for wireless communication. The second apparatus also includes a transmitter that transmits one or more reference signals using one or more resources configured by RAN and a receiver that receives a sequence of beams from the UE, where the sequence of beams contains a series of best beams for a period of time.

In various embodiments, the wireless communication includes downlink transmission, uplink reception, or a combination thereof. In some embodiments, receiving the sequence of beams includes receiving a duration for which each of the beams in the reported sequence are applicable to be used for wireless communication.

In certain embodiments, receiving the duration for which each of the beams in the reported sequence are applicable to be used for wireless communication includes receiving a single duration that is applicable for each of the beams within the reported sequence. In certain embodiments, receiving the duration for which each of the beams in the reported sequence are applicable to be used for wireless communication includes receiving a separate duration for each of the beams within the reported sequence.

In certain embodiments, receiving the duration for which each of the beams in the reported sequence are applicable to be used for wireless communication includes receiving a total duration within which the entire sequence of reported beams is applicable. In such embodiments, the processor further determines a separate duration for each of the beams based on a total number of beams in the sequence of beams and the total duration.

In some embodiments, receiving the sequence of beams includes receiving a set of resource index values indicating each of the reported beams within the sequence. In one embodiment, the resource index value includes a CRI. In another embodiment, the resource index value includes a SSBRI.

In some embodiments, the reported sequence of beams corresponds to a sequence of TRPs and each beam within the sequence of beams is associated with a different TRP. In some embodiments, receiving the sequence of beams from the UE includes receiving at least one beam quality for each beam within the sequence of beam, the at least one beam quality containing one or more of: CQI, RI, LI, PMI, L1-RSRP, L1-SINR, or some combination thereof.

In some embodiments, transmitting the configuration to the UE includes configuring the UE with one or more CSI reporting settings with one or more CSI resources settings. In certain embodiments, each CSI reporting setting is associated with one or more of: a channel measurement resource setting, an interference measurements resource setting, or some combination thereof.

In certain embodiments, the UE is configured with a single CSI reporting setting with a single CSI resource setting, where a QCL Type-D assumption of the configured CSI resources to perform CSI measurements is time varying. In certain embodiments, the UE is configured with a single CSI reporting setting with multiple CSI resource settings, where one of the beams within the sequence is associated with a CSI resource setting of the multiple CSI resource settings. In certain embodiments, the UE is configured with multiple CSI reporting settings, each report setting associated with multiple CSI resource settings, where each of the CSI reporting setting corresponds to one of the reported beams within the sequence.

Disclosed herein is a second method for CSI reporting prediction, according to embodiments of the disclosure. The second method may be performed by a network entity, such as the base unit 121, the RAN node 210, and/or the network apparatus 700, described above. The second method includes transmitting a configuration to a UE for reporting a sequence of beams that are applicable for wireless communication. The second method includes transmitting one or more reference signals using one or more resources configured by RAN and receiving a sequence of beams from the UE, where the sequence of beams contains a series of best beams for a period of time.

In various embodiments, the wireless communication includes downlink transmission, uplink reception, or a combination thereof. In some embodiments, receiving the sequence of beams includes receiving a duration for which each of the beams in the reported sequence are applicable to be used for wireless communication.

In certain embodiments, receiving the duration for which each of the beams in the reported sequence are applicable to be used for wireless communication includes receiving a single duration that is applicable for each of the beams within the reported sequence. In certain embodiments, receiving the duration for which each of the beams in the reported sequence are applicable to be used for wireless communication includes receiving a separate duration for each of the beams within the reported sequence.

In certain embodiments, receiving the duration for which each of the beams in the reported sequence are applicable to be used for wireless communication includes receiving a total duration within which the entire sequence of reported beams is applicable. In such embodiments, the second method further includes determining a separate duration for each of the beams based on a total number of beams in the sequence of beams and the total duration.

In some embodiments, receiving the sequence of beams includes receiving a set of resource index values indicating each of the reported beams within the sequence. In one embodiment, the resource index value includes a CRI. In another embodiment, the resource index value includes a SSBRI.

In some embodiments, the reported sequence of beams corresponds to a sequence of TRPs and each beam within the sequence of beams is associated with a different TRP. In some embodiments, receiving the sequence of beams from the UE includes receiving at least one beam quality for each beam within the sequence of beam, the at least one beam quality containing one or more of: CQI, RI, LI, PMI, L1-RSRP, L1-SINR, or some combination thereof.

In some embodiments, transmitting the configuration to the UE includes configuring the UE with one or more CSI reporting settings with one or more CSI resources settings. In certain embodiments, each CSI reporting setting is associated with one or more of: a channel measurement resource setting, an interference measurements resource setting, or some combination thereof.

In certain embodiments, the UE is configured with a single CSI reporting setting with a single CSI resource setting, where a QCL Type-D assumption of the configured CSI resources to perform CSI measurements is time varying. In certain embodiments, the UE is configured with a single CSI reporting setting with multiple CSI resource settings, where one of the beams within the sequence is associated with a CSI resource setting of the multiple CSI resource settings. In certain embodiments, the UE is configured with multiple CSI reporting settings, each report setting associated with multiple CSI resource settings, where each of the CSI reporting setting corresponds to one of the reported beams within the sequence.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method at a User Equipment (UE), the method comprising:
receiving a configuration from a radio access network (“RAN”) to report a sequence of beams that are applicable for wireless communication;
performing beam quality measurements on resources configured by the RAN;
determining a sequence of beams based on the measurements, wherein the sequence of beams comprises a series of best beams for a period of time; and
reporting the sequence of beams to the RAN.

2. The method of claim 1, wherein reporting the sequence of beams comprises reporting a duration for which each of the beams in the reported sequence are applicable to be used for wireless communication, wherein the wireless communication comprises downlink reception, uplink transmission, or a combination thereof.

3. The method of claim 2, wherein reporting a duration for which each of the beams in the reported sequence are applicable to be used for wireless communication comprises reporting a single duration that is applicable for each of the beams within the reported sequence.

4. The method of claim 2, wherein reporting a duration for which each of the beams in the reported sequence are applicable to be used for wireless communication comprises reporting a separate duration for each of the beams within the reported sequence.

5. The method of claim 2, wherein reporting a duration for which each of the beams in the reported sequence are applicable to be used for wireless communication comprises reporting a total duration within which the entire sequence of reported beams is applicable, wherein a separate duration for each of the beams is determinable based on a total number of beams in the sequence of beams and the total duration.

6. The method of claim 1, wherein reporting the sequence of beams comprises indicating each of the reported beams within the sequence by a resource index value, said resource index value comprising one of: a Channel State Information Reference Signal Resource Index (“CRI”), and a Synchronization Signal/Physical Broadcast Channel Block Resource Index (“SSBRI”).

7. The method of claim 1, wherein the reported sequence of beams corresponds to a sequence of Transmission Reception Points (“TRPs”), wherein each beam within the sequence of beams is associated with a different Transmission Reception Point (“TRP”).

8. The method of claim 1, wherein reporting the sequence of beams to the RAN comprises reporting at least one beam quality for each beam within the sequence of beam, the at least one beam quality comprising one or more of: Channel Quality Indicator (“CQI”), Rank Indicator (“RI”), Layer Indicator (“LI”), Precoding Matrix Indicator (“PMI”), Layer-1 Reference Signal Received Power (“L1-RSRP”), Layer-1 Signal-to-Interference-Plus-Noise Ratio (“L1-SINR”), or some combination thereof.

9. The method of claim 1, wherein receiving the configuration from the RAN comprises receiving a configuration with one or more Channel State Information (“CSI”) reporting settings with one or more CSI resources settings, wherein performing the beam quality measurements comprises performing CSI measurements on multiple configured CSI resources.

10. The method of claim 9, wherein the UE is configured with a single CSI reporting setting with a single CSI resource setting, wherein a Quasi-Co-Location Type-D assumption of the configured CSI resources to perform CSI measurements is time varying.

11. The method of claim 9, wherein the UE is configured with a single CSI reporting setting with multiple CSI resource settings, wherein one of the beams within the sequence is associated with a CSI resource setting of the multiple CSI resource settings.

12. The method of claim 9, wherein the UE is configured with multiple CSI reporting settings, each report setting associated with multiple CSI resource settings, wherein each of the CSI reporting setting corresponds to one of the reported beams within the sequence.

13. The method of claim 9, wherein each CSI reporting setting is associated with one or more of: a channel measurement resource setting, an interference measurements resource setting, or some combination thereof.

14. A UE apparatus comprising:
a receiver that receives a configuration from a radio access network (“RAN”) to report a sequence of beams that are applicable for wireless communication; and
a processor that:
performs beam quality measurements on resources configured by the RAN;
determines a sequence of beams based on the measurements, wherein the sequence of beams comprises a series of best beams for a period of time; and
a transmitter that reports the sequence of beams to the RAN.

15. A Radio Access Network (“RAN”) apparatus, the apparatus comprising:
a processor that configures a User Equipment device (“UE”) for reporting a sequence of beams that are applicable for wireless communication;
a transmitter that transmits one or more reference signals using one or more resources configured by RAN; and
a receiver that receives a sequence of beams from the UE, wherein the sequence of beams comprises a series of best beams for a period of time.
